(19) United States
(12) Patent Application Publication
(10) Pub. No.: US 2025/0048168 A1
(43) Pub. Date: Feb. 6, 2025

(54) Configuring a User Equipment to Operate as a Cell on the Fly

(71) Applicant: Telefonaktiebolaget LM Ericsson (publ), Stockholm (SE)

(72) Inventors: Jan Christoffersson, Luleå (SE); Mårten Ericson, Gammelstad (SE); Stefan Wänstedt, Luleå (SE); Bikramjit Singh, Raasepori (FI); Majid Gerami, Lund (SE)

(21) Appl. No.: 18/716,602

(22) PCT Filed: Dec. 13, 2021
(86) PCT No.: PCT/SE2021/051235

§ 371 Date: Jun. 5, 2024

(51) Int. Cl. H04W 28/02; H04L 5/00; H04W 36/00; H04W 36/22; H04W 72/25; H04W 72/51

(52) U.S. Cl. CPC H04W 28/0215; H04L 5/0035; H04W 36/0094; H04W 36/033; H04W 36/22; H04W 72/25; H04W 72/51

(57) ABSTRACT

A method in a coordinator user equipment, UE, (2612A, 2612B, 2612C, 2612D, 2700 3008A, 3008B, 3106) in a network includes transmitting (801) an indication to a base station (2800) that the coordinator UE is capable of being a cell on the fly. The method includes transmitting (805) load measurement information in a message to the base station. The method includes switching (807) to cell on the fly operation based on the load measurement information. The method includes establishing (809) a backhaul link to the base station. The method includes operating (811) as a cell for other UEs.

### TECHNICAL FIELD

The present disclosure relates generally to communications, and more particularly to communication methods and related devices and nodes supporting wireless communications for a user equipment (UE) to become a cell on the fly including as a transmission and reception point (TRP).

### BACKGROUND

There are scenarios where the physical distribution of UEs within a cell form clusters or groups. In each cluster/group of UEs, there is one coordinator UE and a number of group UEs connected to the coordinator UE. FIG. 1 illustrates a group sidelink (SL) communication scenario where the UEs within the group can communicate via SL transmissions. Thus, the UEs in group 1 communicate with other UEs in group 1. Similar UEs in group 2 and UEs in group 3 communicate with other UEs in group 2 and UEs in group 3, respectively.

A coordinator UE (e.g., coordinator UEs 1, 2, and 3 in FIG. 1) within a group can schedule other UEs in the group on the uplink (UL). This is enabled by using, e.g., configured grants in the UL that the UEs in the group can use, but only after being scheduled by the coordinator UE.

### System Information

The 3rd Generation Partnership Project (3GPP) technical standard (TS) 38.331 section 5.2.1 provides that system information (SI) is divided into the master information block (MIB) and a number of system information blocks (SIBs) where:
the MIB is always transmitted on the broadcast channel (BCH) with a periodicity of 80 ms and repetitions made within 80 ms (TS 38.212, clause 7.1) and it includes parameters that are needed to acquire SIB1 from the cell. The first transmission of the MIB is scheduled in subframes as defined in TS 38.213 [13], clause 4.1 and repetitions are scheduled according to the period of synchronization signal block (SSB);
the SIB1 is transmitted on the downlink (DL)-shared channel (SCH) with a periodicity of 160 ms and variable transmission repetition periodicity within 160 ms as specified in TS 38.213 [13], clause 13. The default transmission repetition periodicity of SIB1 is 20 ms but the actual transmission repetition periodicity is up to network implementation. For SSB and CORESET (Core Resource Set) multiplexing pattern 1, SIB1 repetition transmission period is 20 ms. For SSB and CORESET multiplexing pattern 2/3, SIB1 transmission repetition period is the same as the SSB period (TS 38.213 [13], clause 13). SIB1 includes information regarding the availability and scheduling (e.g. mapping of SIBs to SI message, periodicity, SI-window size) of other SIBs with an indication whether one or more SIBs are only provided on-demand and, in that case, the configuration needed by the UE to perform the SI request. SIB1 is cell-specific SIB;
The mapping of SIBs to SI messages is configured in schedulingInfoList;
For a UE in RRC_CONNECTED, the network can provide system information through dedicated signalling using the RR (Reconfiguration message, e.g. if the UE has an active BWP with no common search space configured to monitor system information, paging, or upon request from the UE;
For primary secondary cell (PSCell) and secondary cells (SCells), the network provides the required SI by dedicated signalling, i.e. within an RRC Reconfiguration message. Nevertheless, the UE shall acquire MIB of the PSCell to get sequence frame number (SFN) timing of the secondary cell group (SCG) (which may be different from master cell group (MCG)). Upon change of relevant SI for SCell, the network releases and adds the concerned SCell. For PSCell, the required SI can only be changed with Reconfiguration with Sync.

### Random Access and Setup/Reconfigure of a UE

When the is inactive (or the mobile is turned off), the UE is in the IDLE mode. When it receives a wake-up from a page message or if the user of the UE wants to access the network, the UE tries to enter the CONNECTED mode by using the radio resource control (RRC) setup procedure specified by 3GPP. A typical setup for the UE is depicted in FIG. 2. The UE starts by listening on the system information, namely the MIB which in turn points to where (or when) the UE can listen to the SIB1 and so on. By this it can deduce how to receive the necessary information for making a random access. This is typically done by a 4-step procedure, msg1 to msg4.

The RRC Setup typically contains information on how to configure the signaling radio bearer 1 (SRB1), i.e. the radioBearerConfig IE. The SRB1 is necessary for the UE to perform any security setup and/or any further reconfiguration.

FIG. 3 shows a more detailed description of the signaling at setup, after SRB1 is established (i.e. after RRC setup is completed). The UE context is fetched from the access and mobility management (AMF) if necessary (message 4-5 below).

Turing to FIG. 3, in operation 1, the UE requests to setup a new connection from RRC_IDLE.

In operation 2/2a. The gNB completes the RRC setup procedure.

NOTE: The scenario where the gNB rejects the request is described below.

In operation 3. The first non-access-stratum (NAS) message from the UE, piggybacked in RRCSetupComplete, is sent to AMF.

In operations 4/4a/5/5a. Additional NAS messages may be exchanged between UE and AMF, see TS 23.502 [22].

In operation 6. The AMF prepares the UE context data (including protocol data unit (PDU) session context, the Security Key, UE Radio Capability and UE Security Capabilities, etc.) and sends it to the gNB.

In operation 7/7a. The gNB activates the access stratum (AS) security with the UE.

In operation 8/8a. The gNB performs the reconfiguration to setup SRB2 and data radio bearers (DRBs).

In operation 9. The gNB informs the AMF that the setup procedure is completed.

NOTE 1: RRC messages in steps 1 and 2 use SRB0, all the subsequent messages use SRB1. Messages in steps 7/7a are integrity protected. From step 8 on, all the messages are integrity protected and ciphered. NOTE 2: For signalling only connection, step 8 is skipped since SRB2 and DRBs are not setup.

### RRC Reconfiguration Information Elements

The RRCReconfiguration contains several information elements (IEs), see below the RRCReconfiguration for EN-DC (evolved-universal terrestrial radio access-new radio dual connectivity):

| | |
|---|---|
| RRCReconfiguration-IEs ::= | SEQUENCE { |
| radioBearerConfig | OPTIONAL, -- Need M |
| secondaryCellGroup | OCTET STRING (CONTAINING CellGroupConfig) OPTIONAL, -- |

Need M

| | |
|---|---|
| measConfigMeasConfig | OPTIONAL, -- Need M |
| lateNonCriticalExtension | OCTET STRING OPTIONAL, |
| nonCriticalExtension | SEQUENCE { } OPTIONAL |

The radioBearerConfig in turn contains the configuration for SRBs, DRBs and security. The security contains which algorithms to use for the UE. The SRB and DRB configurations are mostly related to the upper layer such as PDCP (packet data convergence protocol) and resource block (RB) identity. Note that this radioBearerConfig IE is also used when the UE is performing setup, i.e. radioBearerConfig is part of the RRC Setup (but then only for SRB1).

The secondaryCellGroup is the NR configuration in EN-DC (and thus the name “secondary” here since it is the NR cell by default in EN-DC). Note that the structure is similar for the NR stand-alone but we select to not show that here for simplicity.

measConfigMeasConfig need not be described herein.

The secondaryCellGroup contains the IE CellGroupConfig. This is configurations for radio link control (RLC), medium access control (MAC) and physical configurations. The CellGroupConfig can be configured for both primary cell group and a secondary cell group (even if it does say secondary cell group in the name). Also, this IE CellGroupConfig is used at RRC Setup but then only for configuring SRB1.

CellGroupConfig ::= SEQUENCE {
cellGroupId CellGroupId,

| | |
|---|---|
| rlc-BearerToAddModList | SEQUENCE (SIZE(1..maxLC-ID)) OF RLC-Bearer-Config |

OPTIONAL,

| | |
|---|---|
| rlc-BearerToReleaseList | SEQUENCE (SIZE(1..maxLC-ID)) OF LogicalChannelIdentity |

OPTIONAL,

| mac-CellGroupConfig | OPTIONAL, | |
|---|---|---|
| physicalCellGroupConfig | PhysicalCellGroupConfig | OPTIONAL, |
| spCellConfig | SpCellConfig | OPTIONAL, |

| | |
|---|---|
| sCellToAddModList | SEQUENCE (SIZE (1..maxNrofSCells)) OF SCellConfig |

OPTIONAL,

| | |
|---|---|
| sCellToReleaseList | SEQUENCE (SIZE (1..maxNrofSCells)) OF SCellIndex |

OPTIONAL,
}

The CellGroupConfig also contains the spCellConfig IE. This has a special purpose when the UE performs a handover, which in case the ReconfigurationWithSync is present. The ReconfigurationWithSync is IE is used to configure cell specific parameters of a UE's serving cell.

SpCellConfig ::= SEQUENCE {

| servCellIndex | ServCellIndex OPTIONAL, | -- Cond SCG |
|---|---|---|
| reconfiguration WithSync | Reconfiguration WithSync | OPTIONAL, |
| rlf-TimersAndConstants | setupRelease { RLF-TimersAndConstants } OPTIONAL, -- | |
| Need M | | |
| rlmInSyncOutOfSyncThreshold | INTEGER (0..1) | OPTIONAL, -- Need M |
| spCellConfigDedicated | ServingCellConfig | OPTIONAL, -- Need M |

...
}

The spCellConfig in turns point to several IEs with a structure illustrated below. spCellConfig
servCellIndex
reconfiguration WithSync
spCellConfigCommon (PhysCellId)
new UE-Identity (RNTI for RACH for accessing the PhysCellId)
t304
rach-ConfigDedicated
smtc (SSB based measurement timing configuration)
rlf-TimersAndConstants
rlmInSyncOutOfSyncThresh
spCellConfigDedicated

The Reconfiguration WithSync contains the new cell's RNTI (radio network temporary identifier) value for the UE as well as the dedicated RACH (random access channel) configuration The ReconfigurationWithSync also contains the ServingCellConfigCommon IE which is described further below.

| Reconfiguration WithSync ::= | SEQUENCE { | |
|---|---|---|
| spCellConfigCommon | ServingCellConfigCommon | OPTIONAL, -- Need M |

| | |
|---|---|
| newUE-Identity | RNTI-Value, |
| t304 | ENUMERATED {ms50, ms100, ms150, ms200, ms500, ms1000 |
| | , ms2000, ms10000}, |
| rach-ConfigDedicated | CHOICE { |
| uplink | RACH-ConfigDedicated, |
| supplementaryUplink | RACH-ConfigDedicated |
| } | OPTIONAL, -- Need N |

The SpCellConfig IE also contains a ServingCellConfig IE field. It is used to configure the UE with a serving cell. This is mostly UE specific but partly also cell specific for example the bandwidth parts

| | |
|---|---|
| ServingCellConfig ::= | SEQUENCE { |
| tdd-UL-DL-ConfigurationDedicated | TDD-UL-DL-ConfigDedicated OPTIONAL, -- Cond |
| TDD | |
| initialDownlinkBWP | BWP-DownlinkDedicated OPTIONAL, -- Cond ServCellAdd |
| downlinkBWP-ToReleaseList | SEQUENCE (SIZE (1..maxNrofBWPs)) OF BWP-Id |
| OPTIONAL, | |
| downlinkBWP-ToAddModList | SEQUENCE (SIZE (1..maxNrofBWPs)) OF BWP- |
| Downlink OPTIONAL | |
| firstActiveDownlinkBWP-Id | BWP-Id OPTIONAL, -- Need R |
| bwp-Inactivity Timer | ENUMERATED {ms2, ms3, ms4, ms5, ms6, ms8, ms10, ms20, |
| | ms30, ms40,ms50, ms60, ms80, ms100, ms200, |
| | ms300, ms500, ms750, ms1280, ms1920, ms2560, |
| | spare10, spare9, spare8, spare7, spare6, |
| | spare5, spare4, spare3, spare2, spare1 } |
| OPTIONAL, | |
| defaultDownlinkBWP-Id | BWP-Id OPTIONAL, -- Need M |
| uplinkConfig | OPTIONAL, -- Cond ServCellAdd-UL |
| supplementary Uplink | UplinkConfig OPTIONAL, -- Cond ServCellAdd-SUL |
| pdsch-ServingCellConfig | SetupRelease { PDSCH-ServingCellConfig } OPTIONAL, -- Need |
| M | |
| csi-MeasConfig | SetupRelease { CSI-MeasConfig } OPTIONAL, -- Need M |
| carrierSwitching | SetupRelease { SRS-CarrierSwitching} OPTIONAL, -- Need M |
| sCellDeactivationTimer | ENUMERATED {ms20, ms40, ms80, ms160, ms200, ms240, ms320, |
| | ms400, ms480, ms520, ms640, ms720, ms840, |
| | ms1280, spare2, spare1} OPTIONAL, -- Cond |
| ServingCellWithoutPUCCH | |
| crossCarrierSchedulingConfig | CrossCarrierSchedulingConfig OPTIONAL, -- Need M |
| tag-Id | TAG-Id, |
| ue-BeamLockFunction | ENUMERATED {enabled} OPTIONAL, -- Need R |
| pathlossReferenceLinking | ENUMERATED {pCell, sCell} OPTIONAL -- Cond SCellOnly |
| } | |

ServingCellConfigCommon IE contains parameters which a UE would typically acquire from SSB or SIBs when accessing the cell from IDLE (to avoid the delay to access the SIBs when the UE performs handover). Note that the ServingCellConfigCommon IE contains the physical cell ID.

ServingCellConfigCommon ::= SEQUENCE {

| | |
|---|---|
| physCellId | PhysCellId |
| downlinkConfigCommon | DownlinkConfigCommon, |
| uplinkConfigCommon | UplinkConfigCommon |
| supplementary UplinkConfig | UplinkConfigCommon |
| n-TimingAdvanceOffset | ENUMERATED { n0, n25600, n39936 } |
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |
| } OPTIONAL, -- Need R, | |
| ssb-periodicity ServingCell | ENUMERATED { ms5, ms10, ms20, ms40, ms80, ms160, |
| | spare2, spare1 }OPTIONAL, -- Need S |
| dmrs-TypeA-Position | ENUMERATED {pos2, pos3}, |
| lte-CRS-ToMatchAround | SetupRelease { RateMatchPatternLTE-CRS } OPTIONAL, |
| rateMatchPatternToAddModList | SEQUENCE (SIZE (1..maxNrofRateMatchPatterns)) OF |
| | RateMatchPattern |
| rateMatchPatternToReleaseList | SEQUENCE (SIZE (1..maxNrofRateMatchPatterns)) OF |
| | RateMatchPatternId |
| ssbsubcarrierSpacing | SubcarrierSpacing |
| tdd-UL-DL-ConfigurationCommon | TDD-UL-DL-ConfigCommon |
| ss-PBCH-BlockPower | INTEGER (−60..50), |
| .. | |
| } | |

### SUMMARY

There currently exist certain challenge(s). For example, in some 6G use cases it can be especially hard to predict where most resources are needed spatially e.g. in a large factory, or a mine, interacting robots etc. Further examples include dense deployments of sensors with dynamic traffic load, i.e. when traffic is triggered simultaneously in spatially small regions. To enable these use case, we may require out of the box solution.

One way to overcome this problem is to over-dimension the network i.e. add new cells (for example IAB nodes connected to the gNB) and split the resources. However, these new cells may quickly become unused (or even obsolete) if the devices or traffic move to another area of the factory/mine. Also, it is a costly way to increase the capacity.

In a normal network that covers a city there will always be a need for coverage and capacity, in a big factory or a mine this is not the case. For example, some areas in a mine can cope with none or very low capacity when that said area is not used any more.

Certain aspects of the disclosure and their embodiments may provide solutions to these or other challenges. Various embodiments provided herein dynamically configure a UE via RRC so that it can becomes a new cell. In other words, the current gNB dynamically configures a coordinator UE in a Prose group or another capable UE in a cell, into a new cell on the fly.

According to some embodiments, a method in a coordinator user equipment, UE, in a network includes transmitting an indication to a base station that the coordinator UE is capable of being a cell on the fly. The method includes transmitting load measurement information in a message to the base station. The method includes switching to cell on the fly operation based on the load measurement information. The method includes establishing a backhaul link to the base station. The method includes operating as a cell for other UEs.

Certain embodiments may provide one or more of the following technical advantage(s). Various embodiments can achieve a cost efficient way to support a high number of devices in a confined area such as a factory by creating cells on the fly based on resource need and location of the devices.

According to some other embodiments, a method in a coordinator user equipment, UE, in a network includes transmitting an indication to a base station that the coordinator UE is capable of being a transmission and reception point, TRP, on the fly. The method includes transmitting load measurement information in a message to the base station. The method includes receiving an indication to apply a configuration provided by the base station for the coordinator UE to operate as a TRP on the fly. The method includes switching to operate as a TRP on the fly operation based on the configuration. The method includes establishing a backhaul link to the base station.

Analogous apparatuses, computer program, and computer program products to the above methods are provided.

According to other embodiments, a method in a network node includes receiving an indication from a UE that the UE is capable of being a cell on the fly. The method includes determining that a load in a vicinity of the UE is above a threshold. The method includes transmitting an indication to the UE to apply a configuration provided by the base station for the UE to become a cell on the fly. The method includes sending a handover command to UEs in the vicinity of the UE to switch to the cell on the fly.

Analogous apparatuses, computer program, and computer program products are provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a group sidelink communication scenario;

FIG. 2 is a signaling diagram illustrating a radio resource control setup procedure when a UE goes from IDLE to CONNECTED mode;

FIG. 3 is a signaling diagram illustrating a UE triggered transition from RRC_IDLE to RRC_CONNECTED;

FIG. 4 is an example of scenarios where cells on the fly according to some embodiments described herein can be used;

FIG. 5A is an illustration of a scenario where the area has low load and that the left coordinator UE is inactive according to some embodiments described herein;

FIG. 5A is an illustration of a scenario where the area by the left coordinator UE has a lot of UEs to support and the base station can dynamically decide to switch the left coordinator UE to a cell on the fly according to some embodiments described herein;

FIG. 6 is a signaling diagram of configuring a coordinator UE to be a cell on the fly according to some embodiments described herein;

FIG. 7 is a signaling diagram of configuring a coordinator UE to be a cell on the fly according to some other embodiments described herein;

FIGS. 8-12 and 18-25 are flow charts illustrating operations of a coordinator UE according to some embodiments described herein;

FIGS. 13-15 are flow charts illustrating operations of a network node according to some embodiments described herein;

FIG. 16 is a diagram illustrating configuring a UE as a transmission and reception point in a single downlink control information (DCI) multi-TRP setting according to some embodiments described herein;

FIG. 17 is a diagram illustrating configuring a UE as a transmission and reception point in a multi-DCI multi-TRP setting according to some embodiments described herein;

FIG. 26 is a block diagram of a communication system in accordance with some embodiments;

FIG. 27 is a block diagram of a user equipment in accordance with some embodiments

FIG. 28 is a block diagram of a network node in accordance with some embodiments;

FIG. 29 is a block diagram of a host computer communicating with a user equipment in accordance with some embodiments;

FIG. 30 is a block diagram of a virtualization environment in accordance with some embodiments; and

FIG. 31 is a block diagram of a host computer communicating via a base station with a user equipment over a partially wireless connection in accordance with some embodiments in accordance with some embodiments.

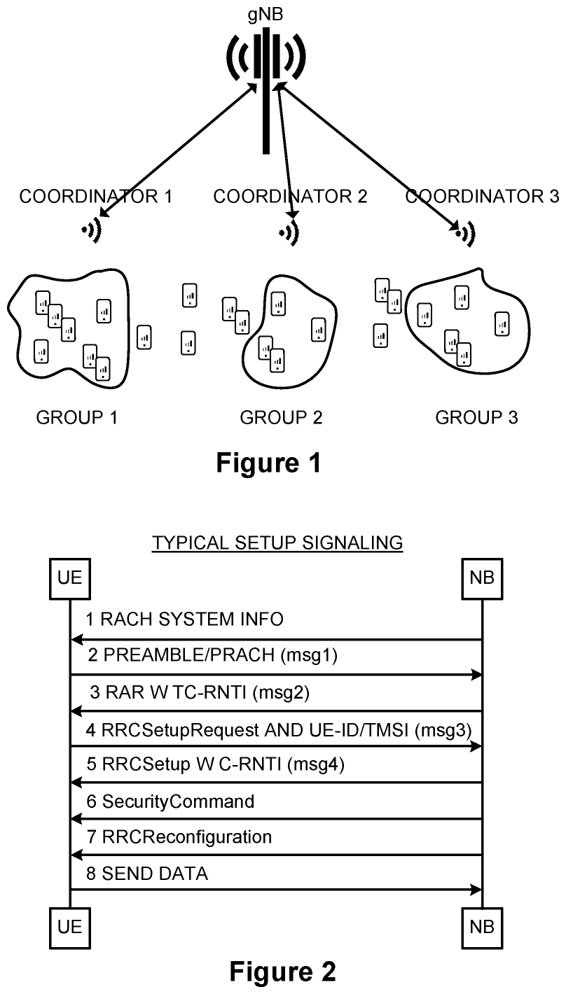

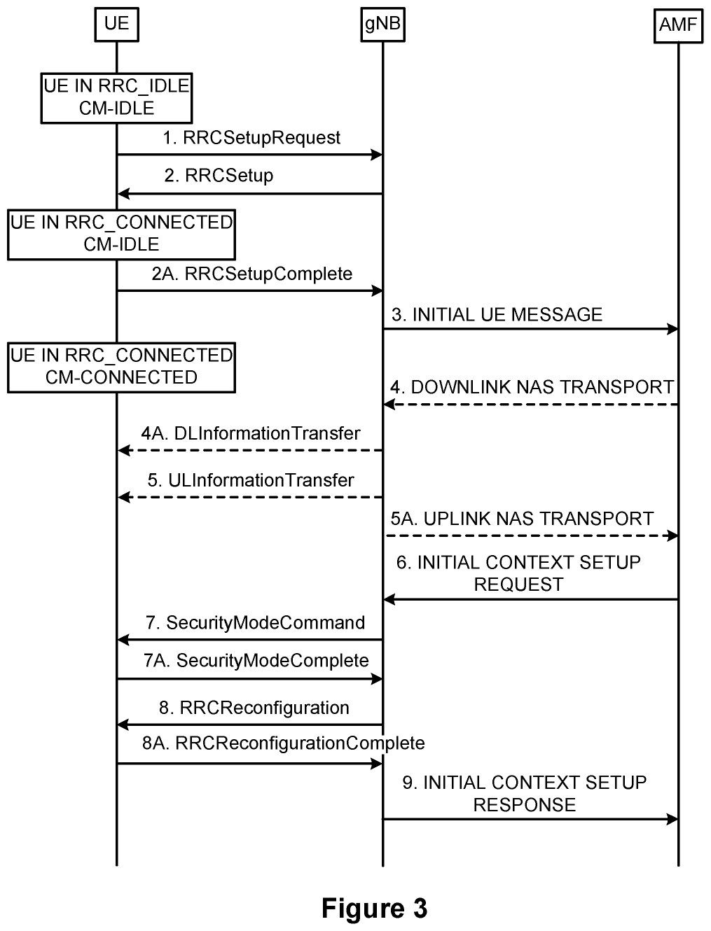

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

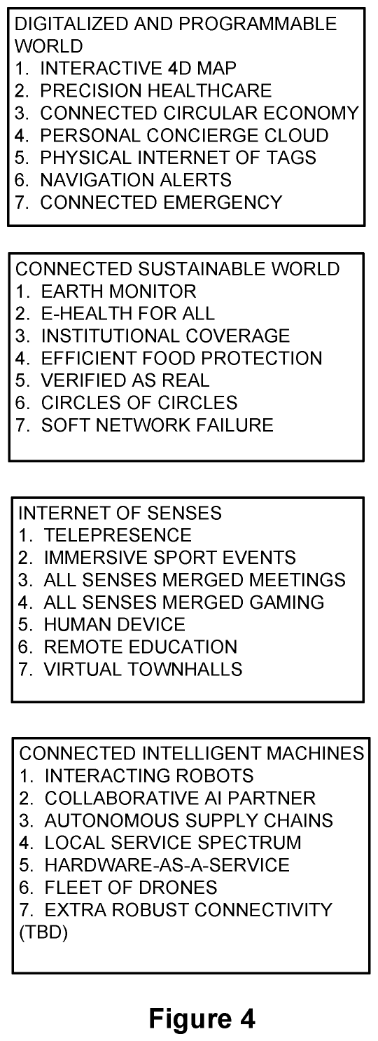

As previously indicated, in a normal network that covers a city there will always be a need for coverage and capacity, in a big factory or a mine this is not always the case and adding dedicated infrastructure for the big factories or mines is not cost effective. FIG. 4 illustrates various use cases where switching a UE to be a cell on the fly can be cost effectively used. For example, in digitalize and programmable world, various use cases include interactive 4D maps, precision healthcare, connected circular economy, personal concierge cloud, physical internet of tags, navigation alerts, connected emergency, etc.

In a connected sustainable word, various use cases include earth monitoring, e-health for all, institutional coverage, efficient food production, verified as real, circles of circles, and soft network failure, etc.

In internet of senses, various use cases includes telepresence, immersive sports events, all senses merged meetings, all senses merged gaming, human device, remote education, and virtual townhalls.

In connected intelligent machines, various use cases includes interacting robots, collaborative artificial intelligence (AI) partner, autonomous supply chains, local service spectrum, hardware-as-a-service, fleet of drones, extra robust activity, etc.

The various embodiments described herein provide methods to dynamically configure a UE via RRC so that it can becomes a new cell. I.e., the current gNB dynamically configures a coordinator in a Prose group or another capable UE in a cell, into a new cell on the fly. We define the term cell on the fly (CotF) which means that a capable UE can be switched into a new IAB node, pico cell, remote radio head, NR cell or similar. Also, the other way around, methods to turn the cell on the fly into a UE are described in various embodiments.

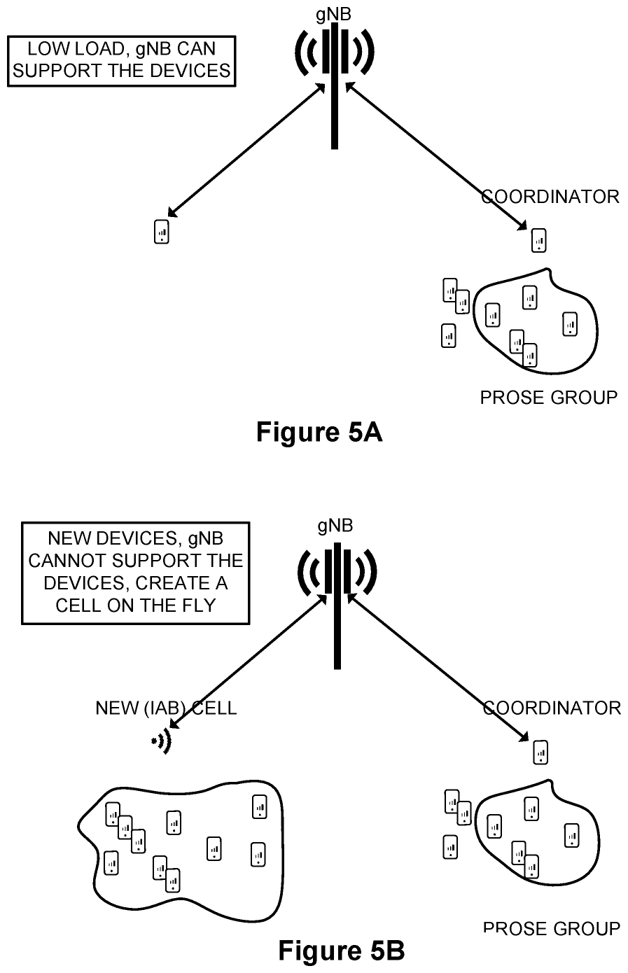

FIG. 5 shows an example of a scenario where this can be beneficial. Assume, for example, a factory where the devices with traffic are first located as in FIG. 5 left figure. The gNB can then handle the load of the whole factory. Then after some time there are several devices in another part of the factory that start to transmit and need to be supported. Most of the time it is most efficient to let the gNB handle all devices itself since it can easily coordinate the resources by scheduling. However, if the resources become scarce, it can be more beneficial to split the cell dynamically and reuse the same resources in the new cell as in the old cell. The gNB decides that it cannot handle this load and also that the two group of devices are relatively separated and will not interfere too much with each other. Therefore, it can be beneficial to create a cell on the fly for the left coordinator.

The UE coordinator has capabilities to be configured to be a cell on the fly and which also can function as a UE.

The cell on the fly is prepared via RRC cell configurations so that the coordinator UE behaves like a normal base station, e.g., the coordinator functionality becomes very similar to a pico cell or a IAB DU where the normal gNB becomes the IAB donor.

The new signaling and how to trigger this new cell on the fly (or the other way around) is described below in further detail.

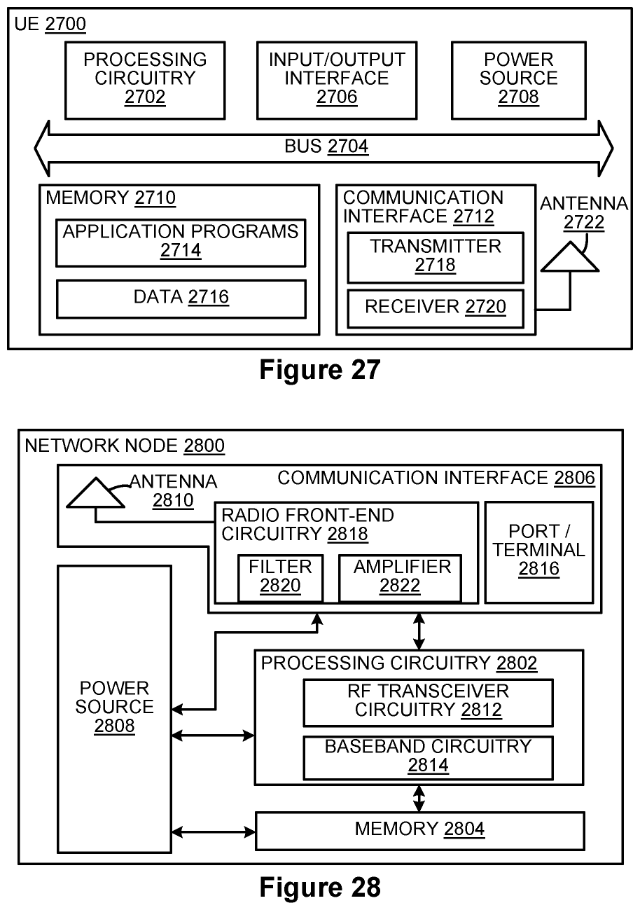

As described below, the coordinator UE, which in various embodiments has the structure of the block diagram of FIG. 27 where modules of coordinator UE (e.g., coordinator UE 2700) may be stored in memory 2710 of FIG. 27, and these modules may provide instructions so that when the instructions of a module are executed by respective coordinator UE processing circuitry 2702, processing circuitry 2702 and/or coordinator UE 2700 performs respective operations of the various flow charts and signaling diagrams with respect to the coordinator UE 2700. FIG. 27, discussed below, describes an embodiment of the coordinator UE 2700 in further detail.

Additionally, the network node, which in various embodiments has the structure of FIG. 28 where modules of the network node (e.g., network node 2800) may be stored in memory 2804 of FIG. 28, and these modules may provide instructions so that when the instructions of a module are executed by respective network processing circuitry 2820, network node 2800 performs respective operations of the flow charts and signaling diagrams with respect to network node 2800. FIG. 28, discussed below, describes an embodiment of the network node 2800 in further detail.

In summary, the various embodiments describe various aspects of how the coordinator UE 2700 and network node 2800 interact. The various aspects include:

The coordinator UE 2700 signals the capability to the network node 2800 that the coordinator UE 2700 has capacity (processing power, antennas, sufficient battery status, etc.) to become a cell on the fly.

The network node 2800 identifies high load (either signaled by coordinator UE 2700 or by other means). The network node signals coordinator UE 2700 to become new cell on the fly. The signaling includes frequency allocation, what SI to transmit, RACH configuration, power settings, Physical Cell ID (PCI), PSS and SSS, security parameters, etc. In principal, the content is similar to what is in the ServingCellConfigCommon IE described above.

### A Backhaul Link to Original gNB is Setup

The cell on the fly starts sending PSS, SSS and SI. The cell may or may not be accessible for all UEs (depending on whether new cell added to white/black cell lists)

The cell on the fly or the original NB sends one single group handover (HO) commands to all UEs belonging to the original group.

Idle/inactive UEs re-select to the cell on the fly in a normal way.

Other UEs may do HO to the cell on the fly by normal HO procedure.

Thus, a network node 2800 configures a capable coordinator UE 2700 to a new second cell when the network node 2800 identifies a high load of the resources of the cell, where the configuration includes at least system information, RACH settings, bandwidth resources, Physical Cell ID (PCI), PSS and SSS, security parameters and a backhaul link between second new cell and first NB. The first NB or the new cell sends one single handover command to UEs in the area of the second new cell to switch to the new second cell. Thus, a cost efficient way to support a high number of devices in a confined area such as a factory by creating cells on the fly based on resource need and location of the devices is described in the various embodiments herein.

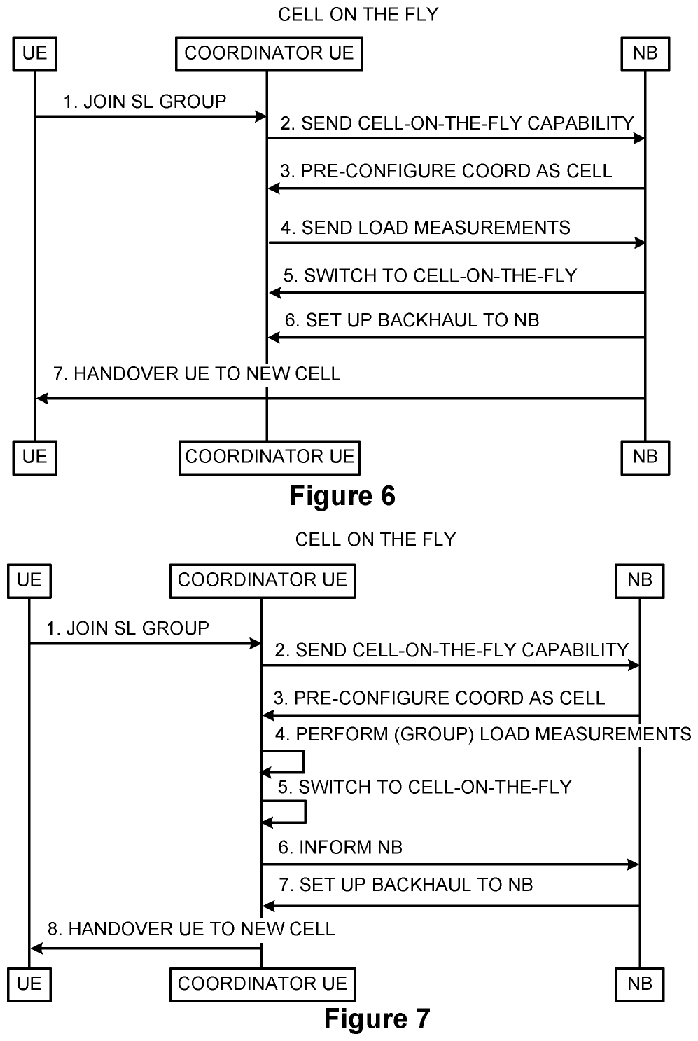

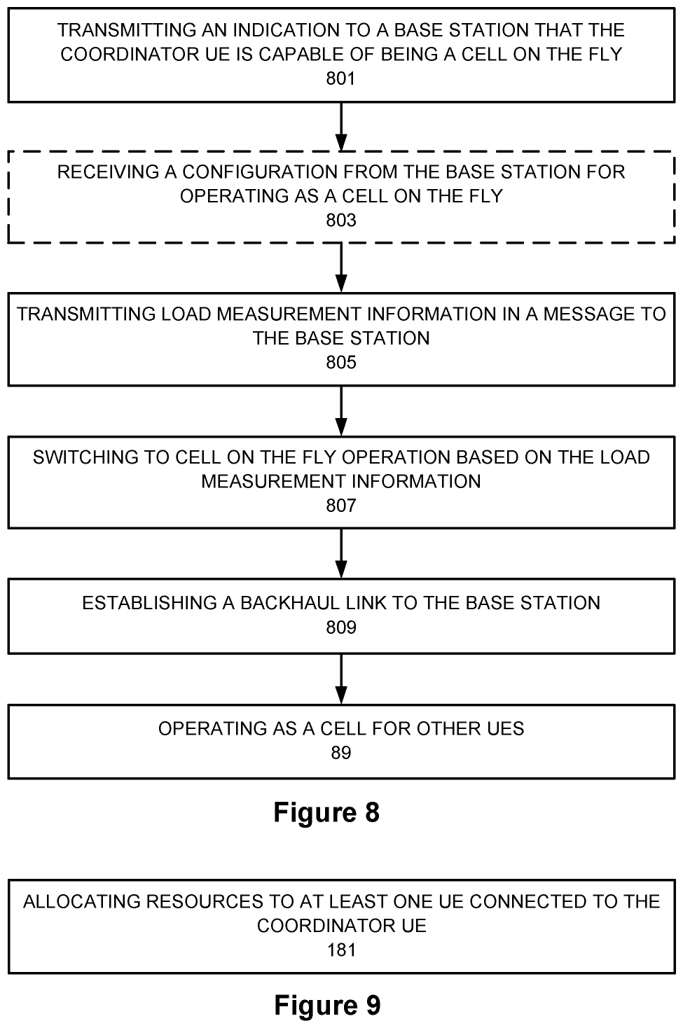

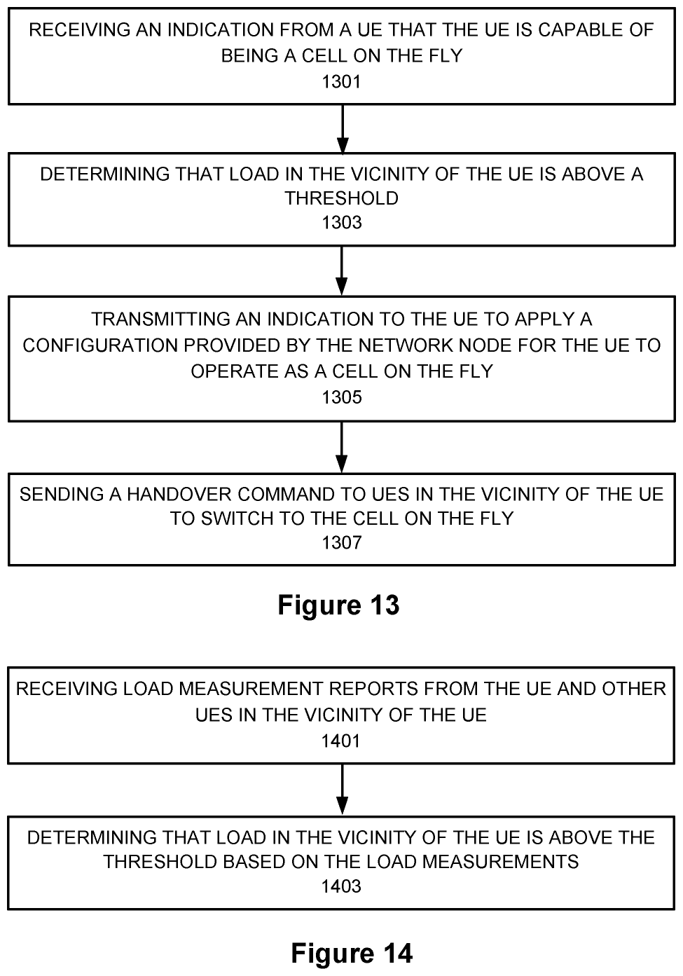

FIG. 6 illustrates a signaling diagram of configuration of a cell on the fly and FIG. 7 illustrates another embodiment of configuration of a cell on the fly. FIGS. 8-12 illustrates operations the coordinator UE 2700 performs in FIGS. 6 and 7. FIGS. 13-15 illustrate operations the network node 2800 performs in FIGS. 6 and 7.

Turning to FIG. 6, in operation 1, UEs join sidelink groups coordinated by coordinator UE 2700. In operation 2, the coordinator UE 2700 sends an indication to the network node 2800 that it is capable of being a cell on the fly and receives a configuration. The network node 2800 can choose to preconfigure the coordinator UE 2700 or send the configurations when it wants the coordinator UE 2700 to switch to a cell in operation 3.

The network node 2800 receives a message or a trigger from the coordinator UE 2700 that the load in the vicinity (e.g. the load of the Prose group in SL or UL/DL) is high in operation 4. The network node 2800 decides to switch the coordinator UE 2700 to a new cell by sending an indication to apply the configuration received in operation 3 to become a cell on the fly.

In operation 7, the network node 2800 and the coordinator UE 2700 establish a backhaul connection between the network node 2800 and the coordinator UE 2700. The network node 2800 send a handover command to all UEs in the group.

FIG. 7 illustrates an alternative embodiment of the configuration procedures of the cell on the fly. As in FIG. 6, UEs join sidelink groups coordinated by coordinator UE 2700 in operation 1. The coordinator UE 2700 sends its capabilities to the network node 2800 and the network node 2800 pre-configures the coordinator UE 2700 (operations 2 and 3). The coordinator UE 2700 then performs load measurements (same as in FIG. 6), but here the coordinator UE 2700 decides itself (without the NB) that it shall switch to a cell, using the per-configured information from the NB in operation 3. The coordinator UE/new cell 2700 then informs the network node 2800 (operation 6) and establishes a backhaul link to the network node 2800 (operation 7) and thereafter sends a handover command to the UEs in the vicinity (or Prose group) (operation 8).

When a “cell on the fly” UE is active, then it broadcasts its identity, synchronization and/or reference signals. Other UEs measure reference signal strength from other gNBs and the cell on the fly. The UE may choose to select/handover to the gNB or “cell on the fly” which can offer best service in terms of better signal to noise ratio SNR or low delay or better signal to interference and noise ratio (SINR) or higher bit rate, etc. Handover command.

The network node 2800 sends the handover command to the UEs that are in the Prose group or UEs close to the coordinator UE 2700. Synchronization settings, timers, TA, etc., can be reused by adapting settings based on calculations. Hence, for devices already RRC_CONNECTED to the network node 2800 no RA is needed to appear in the new cell.

FIGS. 8 to 12 are flowcharts from the perspective of the coordinator UE 2700 in the operations of FIGS. 6 and 7.

Turning to FIG. 8, in block 801, coordinator UE 2700 transmits an indication to a base station (e.g., network node 2800) that the coordinator UE 2700 is capable of being a cell on the fly.

In optional block 803, coordinator UE 2700 receives a configuration from the base station for operating as a cell on the fly. This block is optional since coordinator UE 2700 could be preconfigured with the configuration.

### Configuration Information

The most basic information that needs to be configurable for the cell on the fly is the following:
physCellId-physical cell ID (PCI)
PSS and SSS
System information
Security parameters
Power settings
Bandwidth and carrier frequency—may be a subset of gNB's bandwidth or separate
Bandwidth parts
Placement of PDCCH (control signaling)
FDD/TDD (frequency division duplex/time division duplex) configuration
RACH resources

If the coordinator UE 2700 operating as a cell on the fly is an new integrated access and backhaul (IAB) distributed unit (DU) node, the IAB mobile termination (MT) and the link to the parent IAB node must be set up as stipulated by 3GPP.

The configuration parameters can be communicated by NB/gNB to the coordinator UE 2700 via RRC signaling or SIB or MAC CE signaling. When the network node 2800 wants this coordinator UE 2700 to convert/activate to be a cell on the fly, the network node 2800 can send an activation command over DCI/SIB/RRC signaling indicating physCellId ID #Z in the command. In another embodiment, NB can send an activation command to become cell on the fly by indicating UE ID #Y.

Another option is where the coordinator UE 2700 first sends a request (via RRC, DCI or via a MAC CE based request) to the network node 2800 to be a cell, and then if the request is approved the network node 2800 converts the coordinator UE 2700 into the cell on the fly as described herein.

In one embodiment, the network node 2800 broadcast cell IDs of all possible “cell on the fly” UEs so that other UEs can authenticate to the “cell on the fly” UEs as they are not rogue nodes. In another embodiment, the coordinator UE 2700 operating as a cell on the fly is only visible/useable to the UEs in the original group. This means that it may not be visible for other cells (or be on their whitelists).

The configuration includes frequency allocation, what system information, SI, to transmit, random access channel, RACH, configuration, power settings, bandwidth and carrier frequency, Physical Cell ID, PCI, primary synchronization signal, PSS, and secondary synchronization signal, SSS, and security parameters.

In block 805, coordinator UE 2700 transmits load measurement information in a message to the base station (e.g., network node 2800).

In block 807, coordinator UE 2700 switches to cell on the fly operation based on the load measurement information. In some embodiments, coordinator UE 2700 switches to cell on the fly operation based on the load measurement information by switching to the cell on the fly operation responsive to receiving an indication to apply a configuration provided by the base station (e.g., network node 2800) for the coordinator UE 2700 to operate as a cell on the fly.

In block 809, coordinator UE 2700 establishes a backhaul link to the base station (e.g., network node 2800).

In block 811, coordinator UE 2700 operates as a cell for other UEs. Operating as a cell for other UEs includes broadcasting the PCI, PSS, SSS, and SI towards other UEs in the vicinity of the coordinator UE 2700.

### Scheduling of Resources

Operating as a cell on the fly may also include allocating resources to the UEs connected to the coordinator UE 2700. FIG. 9 illustrates allocating the resources. Turning to FIG. 9, in block 901, the coordinator UE 2700 allocates resources to at least one UE connected to the coordinator UE 2700.

The default behavior of the coordinator UE 2700 operating as a cell on the fly is that it can schedule the new resources to the users without any supervision from the (parent) gNB (e.g., network node 2800) of the cell on the fly. However, in one embodiment, whenever this coordinator UE 2700 schedules other UEs on this spectrum resource, the network node 2800 requires
1. approval (in the form of request) from the gNB or
2. just notification
   to the network node 2800 for any scheduling or resource allocation for the nearby UEs by the “cell on the fly” UE 2700.

Thus, in some embodiments, the coordinator UE 2700 allocates resources to the at least one UE without approval from the network node 2800 and informs the base station (e.g., network node 2800) of the allocation of resources to the at least one UE.

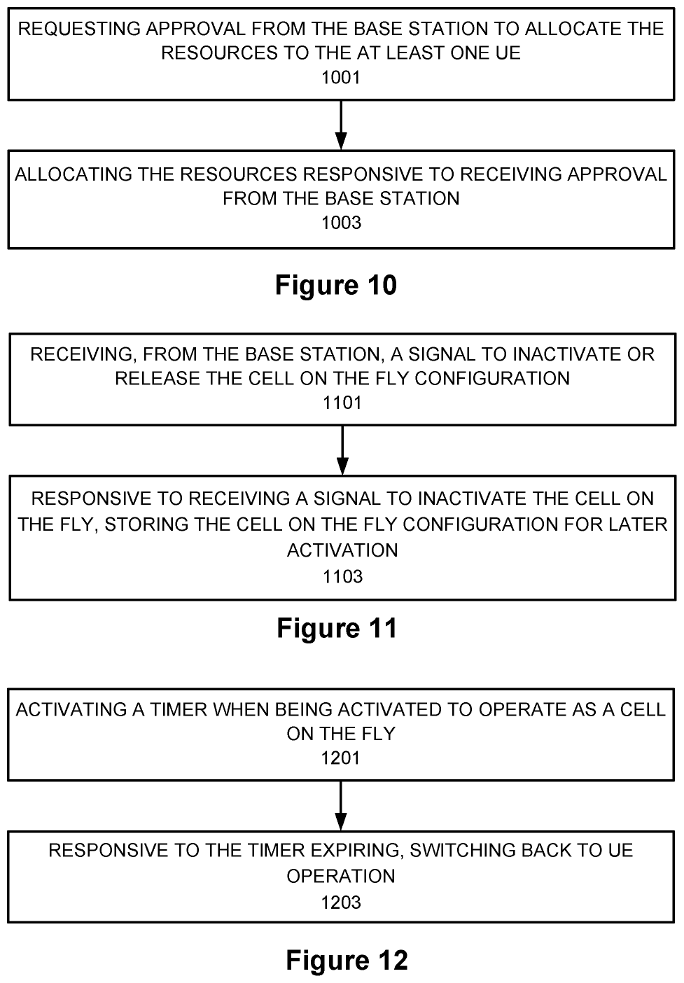

FIG. 10 illustrates another embodiment of allocating resources. Turning to FIG. 10, in block 1001, the coordinator UE 2700 requests approval from the base station (e.g., network node 2800) to allocate the resources to the at least one UE. In block 1003, the coordinator UE 2700, allocates the resources responsive to receiving approval from the base station (e.g., network node 2800).

In another embodiment, the “cell on the fly” UE 2700 is allocated with X number of RACH preambles for neighboring UEs connection at the “cell on the fly” UE 2700. These RACH preambles can be the same preambles the main cell has, so that neighboring UEs if intend to connect to “cell on the fly” UE, then they need not to update their RACH preambles. If a neighboring UE transmits a RACH preamble, then main cell can ignore as it's the “cell on the fly” UE's responsibility to initiate a connection for the neighboring UE.

### Other Configurations

The network node 2800 needs to know which UE has the capability to act as a new cell (i.e., as a cell on the fly). Therefore there is a need for new UE capabilities so that the network node 2800 knows what devices have the capabilities needed to form a new cell, e.g. the device takes the role as network node (to become a cell). The UE also needs to support X2 to handle mobility.

In one embodiment, the “cell on the fly” UE 2700 is configured as a capability. If a UE possesses this capability, then the UE can be allowed to operate as the “cell on the fly” UE 2700.

The new “cell on the fly” is used to serve neighboring UEs to provide following non-limiting services (multiple options can be allowed or not)
1. Data transmission over PUSCH (physical uplink shared channel)
2. Data transmission over PDSCH (physical downlink shared channel
3. Control information (e.g., hybrid automatic repeat request (HARQ)-Acknowledge (ACK) (HARQ-ACK), channel state information (CSI)) transmission over PUSCH
4. Control information transmission over PDSCH
5. Control information transmission over PUCCH (physical uplink control channel)
6. Control information transmission over PDCCH (physical downlink control channel)
7. MAC CE transmission
8. RRC information transmission
9. Data transmission over SL shared channel
10. Control information transmission over SL shared channel
11. Control information transmission over SL control channel

Thus, the coordinator UE 2700 operating as a cell on the fly is configured to provide services to UEs comprising at least one of: data transmission over physical uplink shared channel, PUSCH; data transmission over physical downlink shared channel, PDSCH; control information transmission over PUSCH; control information transmission over physical uplink control channel, PUCCH; control information transmission over physical downlink control channel, PDCCH; medium access control, MAC, control element, CE, transmission; radio resource control, RRC, information transmission; data transmission over sidelink, SL, shared channel; control information transmission over SL shared channel; and control information transmission over SL control channel.

In some other embodiments, the “cell on the fly” UE 2700 is configured to provide services to the nearby UEs. These services include:
1. for certain carriers or cells
2. to utilize certain shared or control resources
3. for specific services, e.g., ultra reliable low latency communications (URLLC), enhanced mobile broadband (eMBB), time sensitive networking (TSN)
4. for certain priority traffic
5. For certain spectrum, e.g., new radio unlicensed (NR-U), shared, NR, LTE spectrum, etc.
6. In another embodiment, the original network node and the “cell-on-the-fly” UE agree on time division duplex (TDD) patterns to avoid intercell interference
7. for certain network slice
8. For certain bandwidth part (BWP)

Thus, the coordinator UE 2700 operating as a cell on the fly is configured to provide services to UEs for at least one of: certain carriers or cells; to utilize certain shared or control resources; specific services; certain priority traffic; a certain spectrum; a certain network slice; and a certain bandwidth part, BWP.

A coordinator UE 27000 that has been configured as a cell on the fly can be reconfigured to become a normal (i.e., coordinator) UE again. The UEs connected to the cell on the fly are handed over to other cells. This can be done by first triggering measurement reports from these UEs and then doing handover.

The network node 2800 signals the cell on the fly to inactivate or release the cell on the fly configuration. In case the configuration is inactivated, the coordinator UE 2700 will store the configuration and it can later be activated again. In case it is released, the coordinator UE 2700 will need to receive a new configuration before becoming a cell on the fly again.

FIG. 11 illustrates operations the coordinator UE 2700 performs when being inactivated or released. Turning to FIG. 11, in block 1101, the coordinator UE 2700 receives, from the base station (e.g., network node 2800), a signal to inactivate or release the cell on the fly configuration. Responsive to receiving a signal to inactivate the cell on the fly, the coordinator UE 2700 stores the cell on the fly configuration for later activation in block 1103.

In some embodiments, the coordinator UE 2700 acting as a cell on the fly switches back to normal operation based on a time duration. FIG. 12 illustrates an embodiment of this. Turning to FIG. 12, in block 1201, the coordinator UE 2700 activates a timer when being activated to operate as a cell on the fly. In block 1203, responsive to the timer expiring, the coordinator UE 2700 switches back to coordinator UE operation. In some embodiments, the “cell on the fly” UE timer is extended, for instance in case the cell-on-the-fly UE 2700 is serving a load.

FIG. 13 illustrates operations the network node 2800 performs with respect to FIGS. 6 and 7. Turning to FIG. 13, in block 1301, the network node 2800 receives an indication from a UE 2700 that the UE 2700 is capable of being a cell on the fly.

In block 1302, the network node 2800 determines that a load in a vicinity of the UE 2700 is above a threshold. In some embodiments, the network node 2800 determines that the load in the vicinity is above the threshold by receiving a message from the UE 2700 that the load is above a threshold.

FIG. 14 illustrates another embodiment of determining that load in the vicinity of the UE is above the threshold. Turning to FIG. 14, in block 1401, the network node 2800 receives load measurement reports from the UE 2700 and other UEs in the vicinity of the UE. In block 1403, the network node 2800 determines that the load in the vicinity is above the threshold based on the load measurements.

Returning to FIG. 13, in block 1305, the network node 2800 transmits an indication to the UE to apply a configuration provided by the network node 2800 for the UE 2700 to become a cell on the fly.

The network node 2800 transmits the configuration to the UE 2700 in some embodiments responsive to receiving the indication from the UE 2700. In other embodiments, the network node 2800 transmits the configuration to the UE 2700 with the indication to apply the configuration.

The configuration includes frequency allocation, what system information, SI, to transmit, random access channel, RACH, configuration, power settings, bandwidth and carrier frequency, Physical Cell ID, PCI, primary synchronization signal, PSS, and secondary synchronization signal, SSS, and security parameters.

Returning to FIG. 13, in block 1307, the network node 2800 sends a handover command to UEs in the vicinity of the UE 2700 to switch to the cell on the fly.

The network nodes 2800 also establishes a backhaul connection from the UE 2700 to the network node 2800.

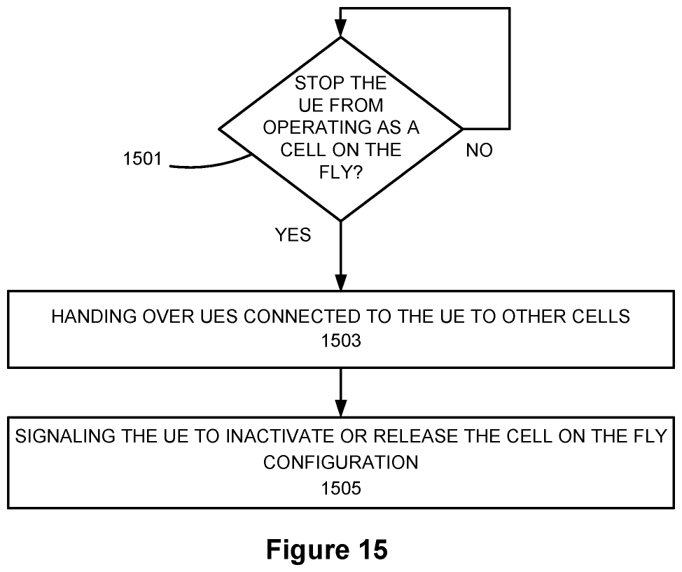

As previously discussed, the coordinator UE 2700 may be deactivated. FIG. 15 illustrates an embodiment of deactivating a cell on the fly UE.

Turning to FIG. 15, in block 1501, the network node 2800 determines whether (or not) to reconfigure the UE 2700 operating as a cell on the fly to stop operating as a cell on the fly. Responsive to determining to reconfigure the UE to stop operating as a cell on the fly, the network node performs blocks 1503 and 1505. In block 1503, the network node 2800 hands over UEs connected to the UE 2700 (operating as a cell on the fly) to other cells. In block 1505, the network node 2800 signals to the UE 2700 to inactivate or to release the cell on the fly configuration.

### A UE as a TRP Point in Multi-TRP Setting

In another embodiment of operating as a cell on the fly, the coordinator UE 2700 can be configured as a transmission and reception point (TRP) in a multi-TRP setting. Here a difference with the embodiments described above is in the fact that TRPs can be in one cell and have the same component carrier (CC). Thus, there is no need for handover to the new cell, as shown in FIG. 6 and FIG. 7.

Two kinds of settings are possible:

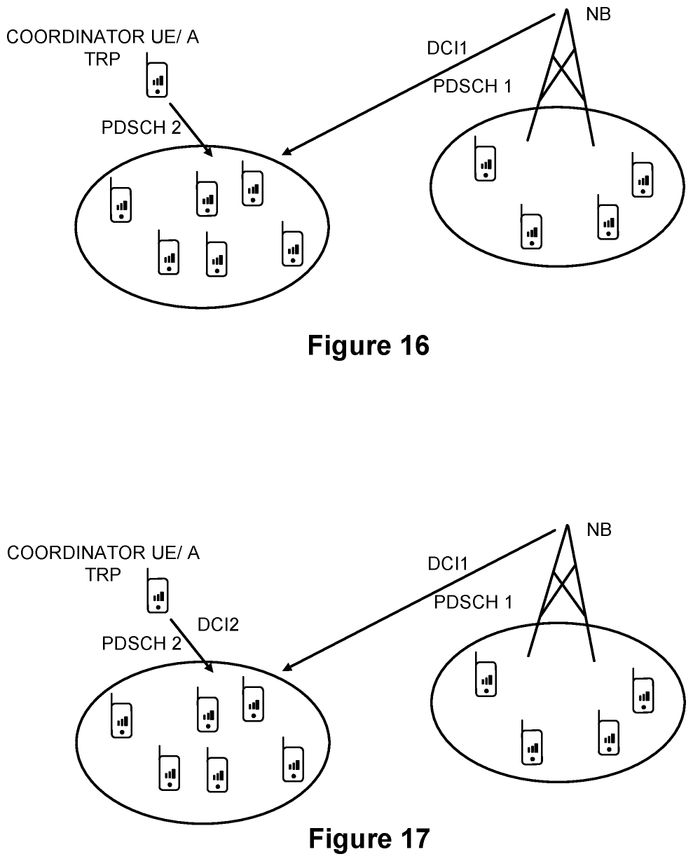

A first kind is a single DCI multi-TRP setting. In this setting, the coordinator UE 2700 does not send PSS, SSS and SI, and DCI to the UEs under its coverage and all the control signaling are sent by the NB. An example has been shown in FIG. 16, where the coordinator UE 2700 plays the role of TRP in the single-DCI multi-TRP setting. Thus, the network node 2800 sends PSS, SSS, and SI as represented by DCI1 in FIG. 16. The network node 2800 and coordinator UE 2700 each provide a PDSCH to UEs using the coordinator UE 2700. This is illustrated as PDSCH1 and PDSCH2 in FIG. 16.

A second kind is a Multi-DCI multi-TRP setting. In this setting, the coordinator UE 2700 performs scheduling and sends control signaling i.e., PSS, SSC and SI, and DCI to the UEs under its coverage as illustrated by DCI2 in the example illustrated in FIG. 17, where the coordinator UE 2700 plays the role of TRP in the multi-DCI multi-TRP setting.

The UE capability for being able to play the role of a TRP is defined. For the UE having that capability, the following process are done in configuring a UE as a TRP Point:
1. The UE (e.g. coordinator UE 2700) sends an indication to the network node 2800 that the UE is capable of being a TRP on the fly and receives a configuration.
2. The network node 2800 can choose to preconfigure the coordinator UE 2700 or send the configurations when the network node 2800 wants the UE 2700 to switch to a new TRP.
3. The network node 2800 receives a message or a trigger from the coordinator UE 2700 that the load in the vicinity (e.g. the load of the Prose group in SL or UL/DL) is high.
4. The network node 2800 decides to switch the coordinator UE 2700 to a new TRP by sending an indication to apply the configuration received to become a TRP on the fly.

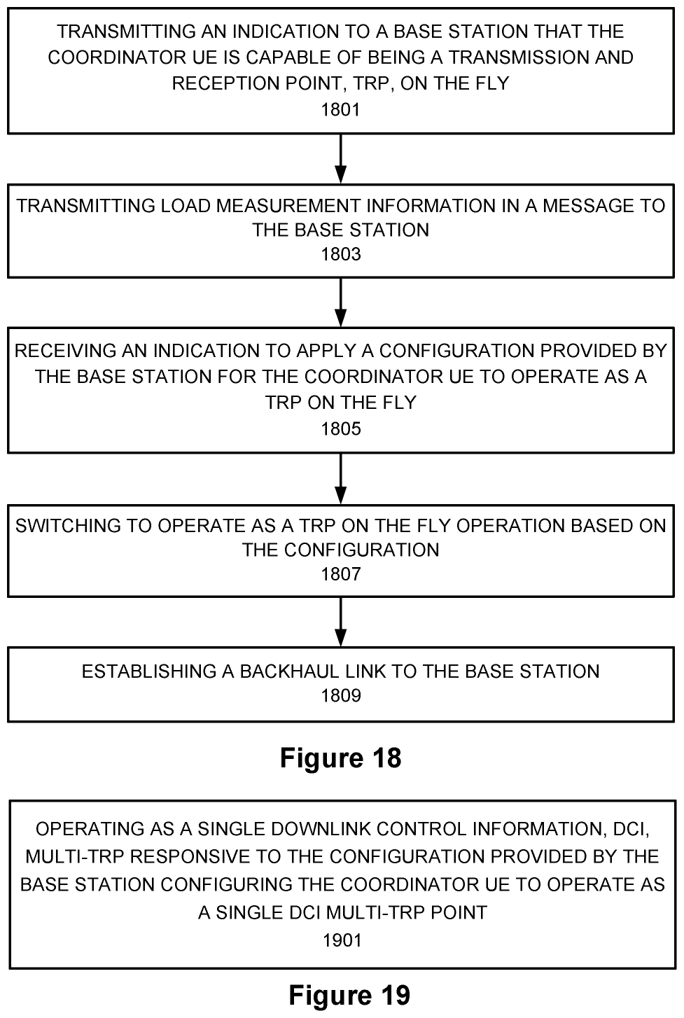

FIG. 18 illustrates operations the coordinator UE 2700 performs with respect to FIGS. 16 and 17. Turning to FIG. 18, in block 1801, the coordinator UE 2700 transmits an indication to a base station (e.g., network node 2800) that the coordinator UE 2700 is capable of being a transmission and reception point, TRP, on the fly. In block 1803, the coordinator UE 2700 transmits load measurement information in a message to the base station (e.g., network node 2800).

In block 1805, the coordinator UE 2700 receives an indication to apply a configuration provided by the base station (e.g., network node 2800) for the coordinator UE to operate as a TRP on the fly. In block 1807, the coordinator UE 2700 switches to operate as a TRP on the fly operation based on the configuration. In block 1809, the coordinator UE 2700 establishes) a backhaul link to the base station.

FIG. 19 illustrates the coordinator UE 2700 operating as a single DCI multi-TRP setting. Turning to FIG. 19, in block 1901, the coordinator UE 2700 operates as a single downlink control information, DCI, multi-TRP responsive to the configuration provided by the base station configuring the coordinator UE to operate as a single DCI multi-TRP point. Operating as a single DCI multi-TRP point includes providing scheduling for data transmission to UEs under coverage of the coordinator UE 2700.

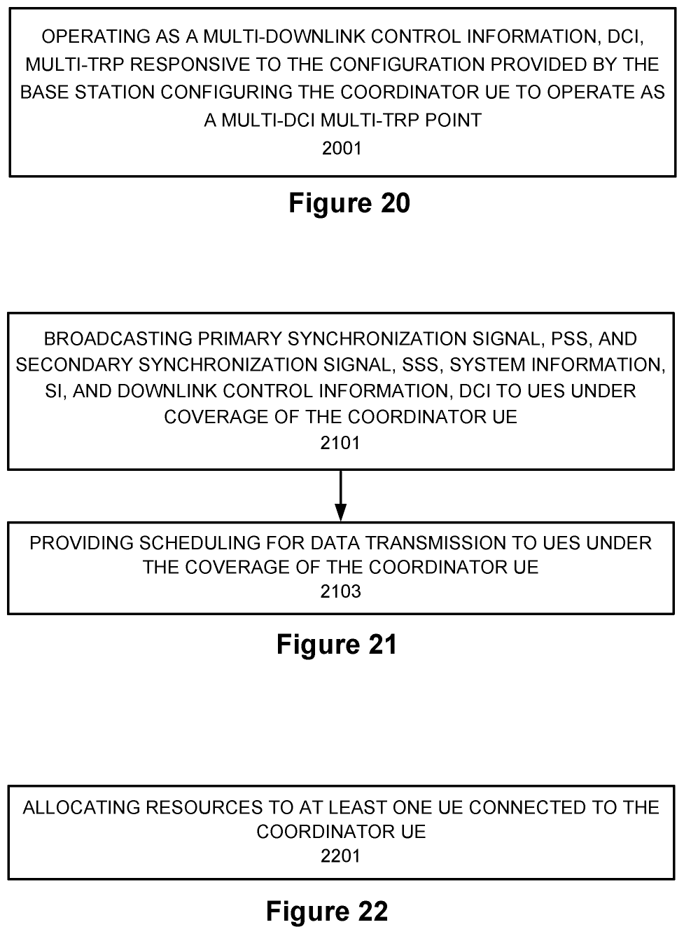

FIG. 20 illustrates the coordinator UE 2700 operating as a multi-DCI multi-TRP setting. Turning to FIG. 20, in block 2001, the coordinator UE 2700 operates as a multi-downlink control information, DCI, multi-TRP responsive to the configuration provided by the base station configuring the coordinator UE to operate as a multi-DCI multi-TRP point.

FIG. 21 illustrates some operations the coordinator UE 2700 operating as a multi-DCI multi-TRP performs. Turning to FIG. 21, in block 2101, the coordinator UE 2700 broadcasts primary synchronization signal, PSS, and secondary synchronization signal, SSS, system information, SI, and downlink control information, DCI to UEs under coverage of the coordinator UE 2700. In block 2103, the coordinator UE 2700 provides scheduling for data transmission to UEs under the coverage of the coordinator UE 2700.

FIGS. 22 to 25 illustrate operations the coordinator UE 2700 may perform in operating as a single DCI multi-TRP and as a multi-DCI multi-TRP.

Operating as a multi-DCI multi-TRP or single DCI multi-TRP may also include allocating resources to the UEs connected to the coordinator UE 2700. FIG. 22 illustrates allocating the resources. Turning to FIG. 22, in block 2201, the coordinator UE 2700 allocates resources to at least one UE connected to the coordinator UE 2700.

The default behavior of the coordinator UE 2700 operating as a multi-DCI multi-TRP or single DCI multi-TRP is that it can schedule the new resources to the users without any supervision from the (parent) gNB (e.g., network node 2800) of the cell on the fly. However, in one embodiment, whenever this coordinator UE 2700 schedules other UEs on this spectrum resource, the network node 2800 requires
3. approval (in the form of request) from the gNB or
4. just notification
   to the network node 2800 for any scheduling or resource allocation for the nearby UEs by the coordinator UE 2700 operating as a multi-DCI multi-TRP or single DCI multi-TRP.

Thus, in some embodiments, the coordinator UE 2700 allocates resources to the at least one UE without approval from the network node 2800 and informs the base station (e.g., network node 2800) of the allocation of resources to the at least one UE.

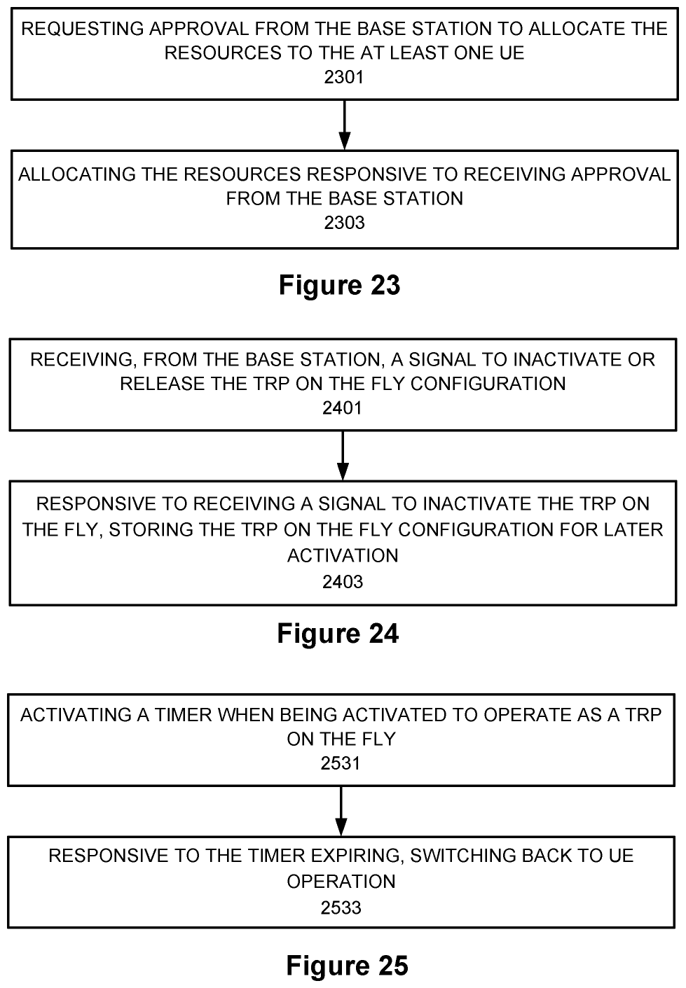

FIG. 23 illustrates another embodiment of allocating resources. Turning to FIG. 23, in block 2301, the coordinator UE 2700 operating as a multi-DCI multi-TRP or single DCI multi-TRP requests approval from the base station (e.g., network node 2800) to allocate the resources to the at least one UE. In block 2303, the coordinator UE 2700, allocates the resources responsive to receiving approval from the base station (e.g., network node 2800).

A coordinator UE 2700 that has been configured as a multi-DCI multi-TRP or single DCI multi-TRP can be reconfigured to become a normal (i.e., coordinator) UE again.

The network node 2800 signals the coordinator UE 2700 operating as a multi-DCI multi-TRP or single DCI multi-TRP to inactivate or release the multi-DCI multi-TRP or single DCI multi-TRP configuration. In case the configuration is inactivated, the coordinator UE 2700 will store the configuration and it can later be activated again. In case it is released, the coordinator UE 2700 will need to receive a new configuration before operating as a multi-DCI multi-TRP or single DCI multi-TRP again.

FIG. 24 illustrates operations the coordinator UE 2700 performs when being inactivated or released. Turning to FIG. 24, in block 2401, the coordinator UE 2700 receives, from the base station (e.g., network node 2800), a signal to inactivate or release the TRP on the fly (i.e., a multi-DCI multi-TRP or single DCI multi-TRP configuration. Responsive to receiving a signal to inactivate the TRP on the fly, the coordinator UE 2700 stores the TRP on the fly configuration for later activation in block 2403.

In some embodiments, the coordinator UE 2700 acting as a TRP on the fly switches back to normal operation based on a time duration. FIG. 25 illustrates an embodiment of this.

Turning to FIG. 25, in block 2501, the coordinator UE 2700 activates a timer when being activated to operate as a TRP on the fly. In block 2503, responsive to the timer expiring, the coordinator UE 2700 switches back to coordinator UE operation. In some embodiments, the “TRP on the fly” UE timer is extended, for instance in case the TRP-on-the-fly UE 2700 is serving a load.

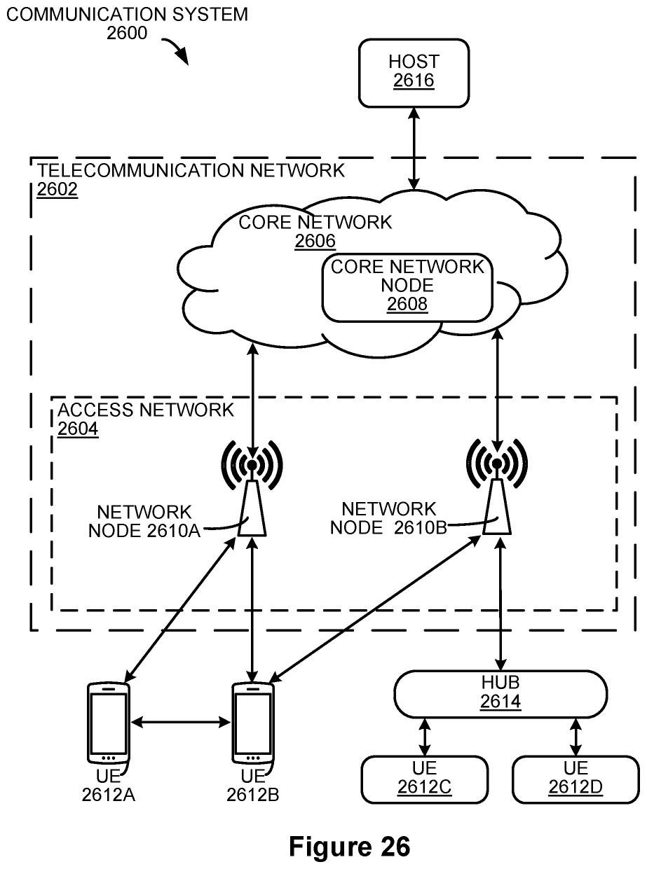

FIG. 26 shows an example of a communication system 2600 in accordance with some embodiments.

In the example, the communication system 2600 includes a telecommunication network 2602 that includes an access network 2604, such as a radio access network (RAN), and a core network 2606, which includes one or more core network nodes 2608. The access network 2604 includes one or more access network nodes, such as network nodes 2610A and 2610B (one or more of which may be generally referred to as network nodes 2610), or any other similar 3rd Generation Partnership Project (3GPP) access node or non-3GPP access point. The network nodes 2610 facilitate direct or indirect connection of user equipment (UE), such as by connecting UEs 2612A, 2612B, 2612C, and 2612D (one or more of which may be generally referred to as UEs 2612) to the core network 2606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2600 may include any number of wired or wireless networks, network nodes, UEs, and/or any other components or systems that may facilitate or participate in the communication of data and/or signals whether via wired or wireless connections. The communication system 2600 may include and/or interface with any type of communication, telecommunication, data, cellular, radio network, and/or other similar type of system.

The UEs 2612 may be any of a wide variety of communication devices, including wireless devices arranged, configured, and/or operable to communicate wirelessly with the network nodes 2610 and other communication devices. Similarly, the network nodes 2610 are arranged, capable, configured, and/or operable to communicate directly or indirectly with the UEs 2612 and/or with other network nodes or equipment in the telecommunication network 2602 to enable and/or provide network access, such as wireless network access, and/or to perform other functions, such as administration in the telecommunication network 2602.

In the depicted example, the core network 2606 connects the network nodes 2610 to one or more hosts, such as host 2616. These connections may be direct or indirect via one or more intermediary networks or devices. In other examples, network nodes may be directly coupled to hosts. The core network 2606 includes one more core network nodes (e.g., core network node 2608) that are structured with hardware and software components. Features of these components may be substantially similar to those described with respect to the UEs, network nodes, and/or hosts, such that the descriptions thereof are generally applicable to the corresponding components of the core network node 2608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2616 may be under the ownership or control of a service provider other than an operator or provider of the access network 2604 and/or the telecommunication network 2602, and may be operated by the service provider or on behalf of the service provider. The host 2616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2600 of FIG. 26 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2602 is a cellular network that implements 3GPP standardized features. Accordingly, the telecommunications network 2602 may support network slicing to provide different logical networks to different devices that are connected to the telecommunication network 2602. For example, the telecommunications network 2602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2612 are configured to transmit and/or receive information without direct human interaction. For instance, a UE may be designed to transmit information to the access network 2604 on a predetermined schedule, when triggered by an internal or external event, or in response to requests from the access network 2604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2614 communicates with the access network 2604 to facilitate indirect communication between one or more UEs (e.g., UE 2612C and/or 2612D) and network nodes (e.g., network node 2610B). In some examples, the hub 2614 may be a controller, router, content source and analytics, coordinator UE, or any of the other communication devices described herein regarding UEs. For example, the hub 2614 may be a broadband router enabling access to the core network 2606 for the UEs. As another example, the hub 2614 may be a controller that sends commands or instructions to one or more actuators in the UEs. Commands or instructions may be received from the UEs, network nodes 2610, or by executable code, script, process, or other instructions in the hub 2614. As another example, the hub 2614 may be a data collector that acts as temporary storage for UE data and, in some embodiments, may perform analysis or other processing of the data. As another example, the hub 2614 may be a content source. For example, for a UE that is a VR headset, display, loudspeaker or other media delivery device, the hub 2614 may retrieve VR assets, video, audio, or other media or data related to sensory information via a network node, which the hub 2614 then provides to the UE either directly, after performing local processing, and/or after adding additional local content. In still another example, the hub 2614 acts as a proxy server or orchestrator for the UEs, in particular in if one or more of the UEs are low energy IoT devices.

The hub 2614 may have a constant/persistent or intermittent connection to the network node 2610B. The hub 2614 may also allow for a different communication scheme and/or schedule between the hub 2614 and UEs (e.g., UE 2612C and/or 2612D), and between the hub 2614 and the core network 2606. In other examples, the hub 2614 is connected to the core network 2606 and/or one or more UEs via a wired connection. Moreover, the hub 2614 may be configured to connect to an M2M service provider over the access network 2604 and/or to another UE over a direct connection. In some scenarios, UEs may establish a wireless connection with the network nodes 2610 while still connected via the hub 2614 via a wired or wireless connection. In some embodiments, the hub 2614 may be a dedicated hub—that is, a hub whose primary function is to route communications to/from the UEs from/to the network node 2610B. In other embodiments, the hub 2614 may be a non-dedicated hub—that is, a device which is capable of operating to route communications between the UEs and network node 2610B, but which is additionally capable of operating as a communication start and/or end point for certain data channels.

FIG. 27 shows a UE 2700 in accordance with some embodiments. As used herein, a UE refers to a device capable, configured, arranged and/or operable to communicate wirelessly with network nodes and/or other UEs. Examples of a UE include, but are not limited to, a coordinator UE, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2700 includes processing circuitry 2702 that is operatively coupled via a bus 2704 to an input/output interface 2706, a power source 2708, a memory 2710, a communication interface 2712, and/or any other component, or any combination thereof. Certain UEs may utilize all or a subset of the components shown in FIG. 27. The level of integration between the components may vary from one UE to another UE. Further, certain UEs may contain multiple instances of a component, such as multiple processors, memories, transceivers, transmitters, receivers, etc.

The processing circuitry 2702 is configured to process instructions and data and may be configured to implement any sequential state machine operative to execute instructions stored as machine-readable computer programs in the memory 2710. The processing circuitry 2702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2702 may include multiple central processing units (CPUs).

In the example, the input/output interface 2706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2708 is structured as a battery or battery pack. Other types of power sources, such as an external power source (e.g., an electricity outlet), photovoltaic device, or power cell, may be used. The power source 2708 may further include power circuitry for delivering power from the power source 2708 itself, and/or an external power source, to the various parts of the UE 2700 via input circuitry or an interface such as an electrical power cable. Delivering power may be, for example, for charging of the power source 2708. Power circuitry may perform any formatting, converting, or other modification to the power from the power source 2708 to make the power suitable for the respective components of the UE 2700 to which power is supplied.

The memory 2710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2710 includes one or more application programs 2714, such as an operating system, web browser application, a widget, gadget engine, or other application, and corresponding data 2716. The memory 2710 may store, for use by the UE 2700, any of a variety of various operating systems or combinations of operating systems.

The memory 2710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2710 may allow the UE 2700 to access instructions, application programs and the like, stored on transitory or non-transitory memory media, to off-load data, or to upload data. An article of manufacture, such as one utilizing a communication system may be tangibly embodied as or in the memory 2710, which may be or comprise a device-readable storage medium.

The processing circuitry 2702 may be configured to communicate with an access network or other network using the communication interface 2712. The communication interface 2712 may comprise one or more communication subsystems and may include or be communicatively coupled to an antenna 2722. The communication interface 2712 may include one or more transceivers used to communicate, such as by communicating with one or more remote transceivers of another device capable of wireless communication (e.g., another UE or a network node in an access network). Each transceiver may include a transmitter 2718 and/or a receiver 2720 appropriate to provide network communications (e.g., optical, electrical, frequency allocations, and so forth). Moreover, the transmitter 2718 and receiver 2720 may be coupled to one or more antennas (e.g., antenna 2722) and may share circuit components, software or firmware, or alternatively be implemented separately.

In the illustrated embodiment, communication functions of the communication interface 2712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2700 shown in FIG. 27.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 28 shows a network node 2800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2800 includes a processing circuitry 2802, a memory 2804, a communication interface 2806, and a power source 2808. The network node 2800 may be composed of multiple physically separate components (e.g., a NodeB component and a RNC component, or a BTS component and a BSC component, etc.), which may each have their own respective components. In certain scenarios in which the network node 2800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2800 may be configured to support multiple radio access technologies (RATs). In such embodiments, some components may be duplicated (e.g., separate memory 2804 for different RATs) and some components may be reused (e.g., a same antenna 2810 may be shared by different RATs). The network node 2800 may also include multiple sets of the various illustrated components for different wireless technologies integrated into network node 2800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2800.

The processing circuitry 2802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2800 components, such as the memory 2804, to provide network node 2800 functionality.

In some embodiments, the processing circuitry 2802 includes a system on a chip (SOC). In some embodiments, the processing circuitry 2802 includes one or more of radio frequency (RF) transceiver circuitry 2812 and baseband processing circuitry 2814. In some embodiments, the radio frequency (RF) transceiver circuitry 2812 and the baseband processing circuitry 2814 may be on separate chips (or sets of chips), boards, or units, such as radio units and digital units. In alternative embodiments, part or all of RF transceiver circuitry 2812 and baseband processing circuitry 2814 may be on the same chip or set of chips, boards, or units.

The memory 2804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2802. The memory 2804 may store any suitable instructions, data, or information, including a computer program, software, an application including one or more of logic, rules, code, tables, and/or other instructions capable of being executed by the processing circuitry 2802 and utilized by the network node 2800. The memory 2804 may be used to store any calculations made by the processing circuitry 2802 and/or any data received via the communication interface 2806. In some embodiments, the processing circuitry 2802 and memory 2804 is integrated.

The communication interface 2806 is used in wired or wireless communication of signaling and/or data between a network node, access network, and/or UE. As illustrated, the communication interface 2806 comprises port(s)/terminal(s) 2816 to send and receive data, for example to and from a network over a wired connection. The communication interface 2806 also includes radio front-end circuitry 2818 that may be coupled to, or in certain embodiments a part of, the antenna 2810. Radio front-end circuitry 2818 comprises filters 2820 and amplifiers 2822. The radio front-end circuitry 2818 may be connected to an antenna 2810 and processing circuitry 2802. The radio front-end circuitry may be configured to condition signals communicated between antenna 2810 and processing circuitry 2802. The radio front-end circuitry 2818 may receive digital data that is to be sent out to other network nodes or UEs via a wireless connection. The radio front-end circuitry 2818 may convert the digital data into a radio signal having the appropriate channel and bandwidth parameters using a combination of filters 2820 and/or amplifiers 2822. The radio signal may then be transmitted via the antenna 2810. Similarly, when receiving data, the antenna 2810 may collect radio signals which are then converted into digital data by the radio front-end circuitry 2818. The digital data may be passed to the processing circuitry 2802. In other embodiments, the communication interface may comprise different components and/or different combinations of components.

In certain alternative embodiments, the network node 2800 does not include separate radio front-end circuitry 2818, instead, the processing circuitry 2802 includes radio front-end circuitry and is connected to the antenna 2810. Similarly, in some embodiments, all or some of the RF transceiver circuitry 2812 is part of the communication interface 2806. In still other embodiments, the communication interface 2806 includes one or more ports or terminals 2816, the radio front-end circuitry 2818, and the RF transceiver circuitry 2812, as part of a radio unit (not shown), and the communication interface 2806 communicates with the baseband processing circuitry 2814, which is part of a digital unit (not shown).

The antenna 2810 may include one or more antennas, or antenna arrays, configured to send and/or receive wireless signals. The antenna 2810 may be coupled to the radio front-end circuitry 2818 and may be any type of antenna capable of transmitting and receiving data and/or signals wirelessly. In certain embodiments, the antenna 2810 is separate from the network node 2800 and connectable to the network node 2800 through an interface or port.

The antenna 2810, communication interface 2806, and/or the processing circuitry 2802 may be configured to perform any receiving operations and/or certain obtaining operations described herein as being performed by the network node. Any information, data and/or signals may be received from a UE, another network node and/or any other network equipment. Similarly, the antenna 2810, the communication interface 2806, and/or the processing circuitry 2802 may be configured to perform any transmitting operations described herein as being performed by the network node. Any information, data and/or signals may be transmitted to a UE, another network node and/or any other network equipment.

The power source 2808 provides power to the various components of network node 2800 in a form suitable for the respective components (e.g., at a voltage and current level needed for each respective component). The power source 2808 may further comprise, or be coupled to, power management circuitry to supply the components of the network node 2800 with power for performing the functionality described herein. For example, the network node 2800 may be connectable to an external power source (e.g., the power grid, an electricity outlet) via an input circuitry or interface such as an electrical cable, whereby the external power source supplies power to power circuitry of the power source 2808. As a further example, the power source 2808 may comprise a source of power in the form of a battery or battery pack which is connected to, or integrated in, power circuitry. The battery may provide backup power should the external power source fail.

Embodiments of the network node 2800 may include additional components beyond those shown in FIG. 28 for providing certain aspects of the network node's functionality, including any of the functionality described herein and/or any functionality necessary to support the subject matter described herein. For example, the network node 2800 may include user interface equipment to allow input of information into the network node 2800 and to allow output of information from the network node 2800. This may allow a user to perform diagnostic, maintenance, repair, and other administrative functions for the network node 2800.

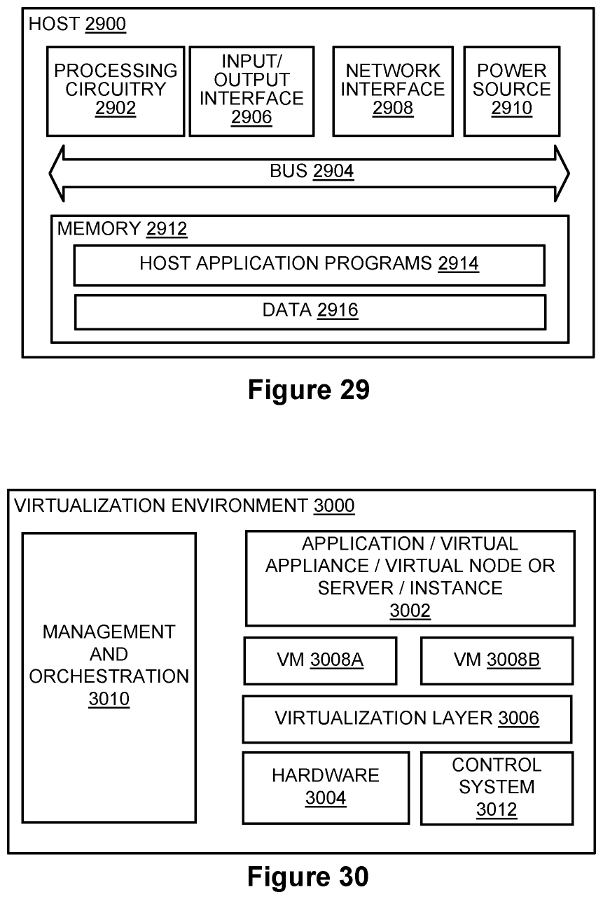

FIG. 29 is a block diagram of a host 2900, which may be an embodiment of the host 2616 of FIG. 26, in accordance with various aspects described herein. As used herein, the host 2900 may be or comprise various combinations hardware and/or software, including a standalone server, a blade server, a cloud-implemented server, a distributed server, a virtual machine, container, or processing resources in a server farm. The host 2900 may provide one or more services to one or more UEs.

The host 2900 includes processing circuitry 2902 that is operatively coupled via a bus 2904 to an input/output interface 2906, a network interface 2908, a power source 2910, and a memory 2912. Other components may be included in other embodiments. Features of these components may be substantially similar to those described with respect to the devices of previous figures, such as FIGS. 27 and 28, such that the descriptions thereof are generally applicable to the corresponding components of host 2900.

The memory 2912 may include one or more computer programs including one or more host application programs 2914 and data 2916, which may include user data, e.g., data generated by a UE for the host 2900 or data generated by the host 2900 for a UE. Embodiments of the host 2900 may utilize only a subset or all of the components shown. The host application programs 2914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2914 may also provide for user authentication and licensing checks and may periodically report health, routes, and content availability to a central node, such as a device in or on the edge of a core network. Accordingly, the host 2900 may select and/or indicate a different host for over-the-top services for a UE. The host application programs 2914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 30 is a block diagram illustrating a virtualization environment 3000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3006 (also referred to as hypervisors or virtual machine monitors (VMMs)), provide VMs 3008a and 3008b (one or more of which may be generally referred to as VMs 3008), and/or perform any of the functions, features and/or benefits described in relation with some embodiments described herein. The virtualization layer 3006 may present a virtual operating platform that appears like networking hardware to the VMs 3008.

The VMs 3008 comprise virtual processing, virtual memory, virtual networking or interface and virtual storage, and may be run by a corresponding virtualization layer 3006. Different embodiments of the instance of a virtual appliance 3002 may be implemented on one or more of VMs 3008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3008 may be a software implementation of a physical machine that runs programs as if they were executing on a physical, non-virtualized machine. Each of the VMs 3008, and that part of hardware 3004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3008 on top of the hardware 3004 and corresponds to the application 3002.

Hardware 3004 may be implemented in a standalone network node with generic or specific components. Hardware 3004 may implement some functions via virtualization. Alternatively, hardware 3004 may be part of a larger cluster of hardware (e.g. such as in a data center or CPE) where many hardware nodes work together and are managed via management and orchestration 3010, which, among others, oversees lifecycle management of applications 3002. In some embodiments, hardware 3004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3012 which may alternatively be used for communication between hardware nodes and radio units.

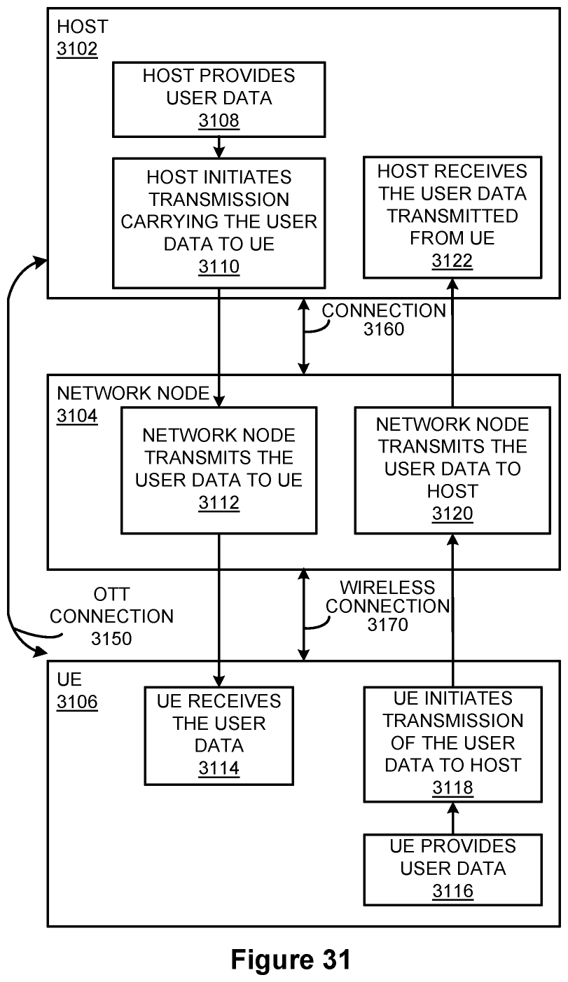

FIG. 31 shows a communication diagram of a host 3102 communicating via a network node 3104 with a UE 3106 over a partially wireless connection in accordance with some embodiments. Example implementations, in accordance with various embodiments, of the UE (such as a UE 2612a of FIG. 26 and/or UE 2700 of FIG. 27), network node (such as network node 2610a of FIG. 26 and/or network node 2800 of FIG. 28), and host (such as host 2616 of FIG. 26 and/or host 2900 of FIG. 29) discussed in the preceding paragraphs will now be described with reference to FIG. 31.

Like host 2900, embodiments of host 3102 include hardware, such as a communication interface, processing circuitry, and memory. The host 3102 also includes software, which is stored in or accessible by the host 3102 and executable by the processing circuitry. The software includes a host application that may be operable to provide a service to a remote user, such as the UE 3106 connecting via an over-the-top (OTT) connection 3150 extending between the UE 3106 and host 3102. In providing the service to the remote user, a host application may provide user data which is transmitted using the OTT connection 3150.

The network node 3104 includes hardware enabling it to communicate with the host 3102 and UE 3106. The connection 3160 may be direct or pass through a core network (like core network 2606 of FIG. 26) and/or one or more other intermediate networks, such as one or more public, private, or hosted networks. For example, an intermediate network may be a backbone network or the Internet.

The UE 3106 includes hardware and software, which is stored in or accessible by UE 3106 and executable by the UE's processing circuitry. The software includes a client application, such as a web browser or operator-specific “app” that may be operable to provide a service to a human or non-human user via UE 3106 with the support of the host 3102. In the host 3102, an executing host application may communicate with the executing client application via the OTT connection 3150 terminating at the UE 3106 and host 3102. In providing the service to the user, the UE's client application may receive request data from the host's host application and provide user data in response to the request data. The OTT connection 3150 may transfer both the request data and the user data. The UE's client application may interact with the user to generate the user data that it provides to the host application through the OTT connection 3150.

The OTT connection 3150 may extend via a connection 3160 between the host 3102 and the network node 3104 and via a wireless connection 3170 between the network node 3104 and the UE 3106 to provide the connection between the host 3102 and the UE 3106. The connection 3160 and wireless connection 3170, over which the OTT connection 3150 may be provided, have been drawn abstractly to illustrate the communication between the host 3102 and the UE 3106 via the network node 3104, without explicit reference to any intermediary devices and the precise routing of messages via these devices.

As an example of transmitting data via the OTT connection 3150, in step 3108, the host 3102 provides user data, which may be performed by executing a host application. In some embodiments, the user data is associated with a particular human user interacting with the UE 3106. In other embodiments, the user data is associated with a UE 3106 that shares data with the host 3102 without explicit human interaction. In step 3110, the host 3102 initiates a transmission carrying the user data towards the UE 3106. The host 3102 may initiate the transmission responsive to a request transmitted by the UE 3106. The request may be caused by human interaction with the UE 3106 or by operation of the client application executing on the UE 3106. The transmission may pass via the network node 3104, in accordance with the teachings of the embodiments described throughout this disclosure. Accordingly, in step 3112, the network node 3104 transmits to the UE 3106 the user data that was carried in the transmission that the host 3102 initiated, in accordance with the teachings of the embodiments described throughout this disclosure. In step 3114, the UE 3106 receives the user data carried in the transmission, which may be performed by a client application executed on the UE 3106 associated with the host application executed by the host 3102.

In some examples, the UE 3106 executes a client application which provides user data to the host 3102. The user data may be provided in reaction or response to the data received from the host 3102. Accordingly, in step 3116, the UE 3106 may provide user data, which may be performed by executing the client application. In providing the user data, the client application may further consider user input received from the user via an input/output interface of the UE 3106. Regardless of the specific manner in which the user data was provided, the UE 3106 initiates, in step 3118, transmission of the user data towards the host 3102 via the network node 3104. In step 3120, in accordance with the teachings of the embodiments described throughout this disclosure, the network node 3104 receives user data from the UE 3106 and initiates transmission of the received user data towards the host 3102. In step 3122, the host 3102 receives the user data carried in the transmission initiated by the UE 3106.

One or more of the various embodiments may improve the performance of OTT services provided to the UE 3106 using the OTT connection 3150, in which the wireless connection 3170 forms the last segment.

In an example scenario, factory status information may be collected and analyzed by the host 3102. As another example, the host 3102 may process audio and video data which may have been retrieved from a UE for use in creating maps. As another example, the host 3102 may collect and analyze real-time data to assist in controlling vehicle congestion (e.g., controlling traffic lights). As another example, the host 3102 may store surveillance video uploaded by a UE. As another example, the host 3102 may store or control access to media content such as video, audio, VR or AR which it can broadcast, multicast or unicast to UEs. As other examples, the host 3102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3150 between the host 3102 and UE 3106, in response to variations in the measurement results. The measurement procedure and/or the network functionality for reconfiguring the OTT connection may be implemented in software and hardware of the host 3102 and/or UE 3106. In some embodiments, sensors (not shown) may be deployed in or in association with other devices through which the OTT connection 3150 passes; the sensors may participate in the measurement procedure by supplying values of the monitored quantities exemplified above, or supplying values of other physical quantities from which software may compute or estimate the monitored quantities. The reconfiguring of the OTT connection 3150 may include message format, retransmission settings, preferred routing etc.; the reconfiguring need not directly alter the operation of the network node 3104. Such procedures and functionalities may be known and practiced in the art. In certain embodiments, measurements may involve proprietary UE signaling that facilitates measurements of throughput, propagation times, latency and the like, by the host 3102. The measurements may be implemented in that software causes messages to be transmitted, in particular empty or ‘dummy’ messages, using the OTT connection 3150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-43. (canceled)

44. A method in a coordinator user equipment (UE) in a network, the method comprising:
transmitting an indication to a base station that the coordinator UE is capable of being a cell on the fly;
transmitting load measurement information in a message to the base station;
switching to cell on the fly operation based on the load measurement information;
establishing a backhaul link to the base station; and
operating as a cell for other UEs.

45. The method of claim 44, wherein switching to cell on the fly operation based on the load measurement information comprises switching to the cell on the fly operation responsive to receiving an indication to apply a configuration provided by the base station for the coordinator UE to operate as a cell on the fly.

46. The method of claim 44, further comprising receiving a configuration from the base station for operating as a cell on the fly.

47. The method of claim 46, wherein the configuration comprises frequency allocation, what system information (SI) to transmit, random access channel (RACH) configuration, power settings, bandwidth and carrier frequency, Physical Cell ID (PCI), primary synchronization signal (PSS), and secondary synchronization signal (SSS), and security parameters.

48. The method of claim 44, wherein operating as a cell for other UEs comprises broadcasting the PCI, PSS, SSS, and SI towards other UEs in the vicinity of the coordinator UE.

49. The method of claim 44, further comprising allocating resources to at least one UE connected to the coordinator UE.

50. The method of claim 49, wherein allocating resources to the at least one UE comprises:
requesting approval from the base station to allocate the resources to the at least one UE; and
allocating the resources responsive to receiving approval from the base station.

51. The method of claim 49, wherein allocating resources to the at least one UE further comprises informing the base station of the allocation of resources to the at least one UE.

52. The method of claim 44, further comprising:
receiving, from the base station, a signal to inactivate or release the cell on the fly configuration;
responsive to receiving a signal to inactivate the cell on the fly, storing the cell on the fly configuration for later activation.

53. The method of claim 44, further comprising:
activating a timer when being activated to operate as a cell on the fly;
responsive to the timer expiring, switching back to UE operation.

54. The method of claim 44, wherein the coordinator UE operating as a cell on the fly is configured to provide services to UEs for at least one of:
certain carriers or cells;
to utilize certain shared or control resources;
specific services;
certain priority traffic;
a certain spectrum;
a certain network slice; and
a certain bandwidth part (BWP).

55. The method of claim 44, wherein the coordinator UE operating as a cell on the fly is configured to provide services to UEs comprising at least one of:
data transmission over physical uplink shared channel (PUSCH);
data transmission over physical downlink shared channel (PDSCH);
control information transmission over (PUSCH);
control information transmission over physical uplink control channel (PUCCH);
control information transmission over physical downlink control channel (PDCCH);
medium access control (MAC) control element (CE) transmission;
radio resource control (RRC) information transmission;
data transmission over sidelink (SL) shared channel;
control information transmission over SL shared channel; and
control information transmission over SL control channel.

56. A method in a coordinator user equipment (UE) in a network, the method comprising:
transmitting an indication to a base station that the coordinator UE is capable of being a transmission and reception point (TRP) on the fly;
transmitting load measurement information in a message to the base station;
receiving an indication to apply a configuration provided by the base station for the coordinator UE to operate as a TRP on the fly;
switching to operate as a TRP on the fly operation based on the configuration; and
establishing a backhaul link to the base station.

57. The method of claim 56, further comprising:
operating as a single downlink control information (DCI) multi-TRP responsive to the configuration provided by the base station configuring the coordinator UE to operate as a single DCI multi-TRP point.

58. The method of claim 57, wherein operating as a single DCI multi-TRP point comprises providing scheduling for data transmission to UEs under coverage of the coordinator UE.

59. The method of claim 56, further comprising:
operating as a multi-downlink control information (DCI) multi-TRP responsive to the configuration provided by the base station configuring the coordinator UE to operate as a multi-DCI multi-TRP point.

60. The method of claim 59, wherein operating as a multi-DCI multi-TRP point comprises:
broadcasting primary synchronization signal (PSS) and secondary synchronization signal (SSS) system information (SI) and downlink control information (DCI) to UEs under coverage of the coordinator UE; and
providing scheduling for data transmission to UEs under the coverage of the coordinator UE.

61. The method of claim 56, further comprising allocating resources to at least one UE connected to the coordinator UE.

62. The method of claim 61, wherein allocating resources to the at least one UE comprises:
requesting approval from the base station to allocate the resources to the at least one UE; and
allocating the resources responsive to receiving approval from the base station.

63. The method of claim 61, wherein allocating resources to the at least one UE further comprises informing the base station of the allocation of resources to the at least one UE.

64. The method of claim 56, further comprising:
receiving, from the base station, a signal to inactivate or release the TRP on the fly configuration;
responsive to receiving a signal to inactivate the TRP on the fly, storing the TRP on the fly configuration for later activation.

65. The method of claim 56, further comprising:
activating a timer when being activated to operate as a TRP on the fly;
responsive to the timer expiring, switching back to UE operation.

66. A method in a network node for configuring a user equipment (UE), the method comprising:
receiving an indication from a UE that the UE is capable of being a cell on the fly;
determining that a load in a vicinity of the UE is above a threshold;
transmitting an indication to the UE to apply a configuration provided by the network node for the UE to become a cell on the fly; and
sending a handover command to UEs in the vicinity of the UE to switch to the cell on the fly.

67. The method of claim 66, wherein determining that the load in the vicinity is above the threshold comprises receiving a message from the UE that the load is above a threshold.

68. The method of claim 66, wherein determining that the load in the vicinity is above the threshold comprises:
receiving load measurement reports from the UE and other UEs in the vicinity of the UE; and
determining that the load in the vicinity is above the threshold based on the load measurements.

69. A coordinator user equipment, UE, comprising:
processing circuitry; and
memory coupled with the processing circuitry, wherein the memory includes instructions that when executed by the processing circuitry causes the UE to:
transmit an indication to a base station that the coordinator UE is capable of being a cell on the fly;
transmit load measurement information in a message to the base station;
switch to cell on the fly operation based on the load measurement information;
establish a backhaul link to the base station; and
operate as a cell for other UEs.
